(19) United States
(12) Patent Application Publication
(10) Pub. No.: US 2024/0389120 A1
(43) Pub. Date: Nov. 21, 2024

(54) REDUCED CAPABILITY FOR BROADCAST AND MULTICAST IN RRC INACTIVE STATE

(71) Applicant: QUALCOMM Incorporated, San Diego, CA (US)

(72) Inventors: Diana MAAMARI, San Diego, CA (US); Le LIU, San Jose, CA (US); Umesh PHUYAL, San Diego, CA (US); Yongjun KWAK, San Diego, CA (US); Ahmed ELSHAFIE, San Diego, CA (US)

(21) Appl. No.: 18/320,939

(22) Filed: May 19, 2023

(51) Int. Cl. H04W 72/30; H04W 72/512

(52) U.S. Cl. CPC H04W 72/30; H04W 72/512

(57) ABSTRACT

The apparatus may be configured to receive a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth. The apparatus may also be configured to monitor the CFR indicated in the first indication for at least one of broadcast traffic or multicast traffic. The apparatus may be configured to output, for transmission to the plurality of RedCap UEs, the first indication and output, for transmission to the plurality of RedCap UEs, at least one of an MCCH communication or an MTCH communication via the CFR indicated in the first indication for at least one of broadcast traffic or multicast traffic.

### TECHNICAL FIELD

The present disclosure relates generally to communication systems, and more particularly, to a multicast and broadcast service (MBS) for user equipments (UEs) in a wireless network.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or a component of a wireless device configured to receive a first indication of a common frequency resource (CFR) associated with at least one of a multicast control channel (MCCH) or a multicast traffic channel (MTCH) for a plurality of reduced capability (RedCap) UEs in one of an inactive or idle state supporting a first capability having a first maximum bandwidth that is different from a second capability having a second maximum bandwidth that is greater than the first maximum bandwidth. The apparatus may also be configured to monitor the CFR indicated in the first indication for at least one of broadcast traffic or multicast traffic.

In an aspect of the disclosure, a method, a computer-readable medium, and an apparatus are provided. The apparatus may be a network node, a network device or a component of a network node or network device configured to output, for transmission to a plurality of RedCap UEs in one of an inactive or idle state supporting a first capability having a first maximum bandwidth that is different from a second capability having a second maximum bandwidth that is greater than the first maximum bandwidth, a first indication of a CFR associated with at least one of an MCCH or an MTCH for the plurality of RedCap UEs. The apparatus may also be configured to output, for transmission to the plurality of RedCap UEs, at least one of an MCCH communication or an MTCH communication via the CFR indicated in the first indication for at least one of broadcast traffic or multicast traffic.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a diagram illustrating an example of MBS areas in an access network.

FIG. 4B is a diagram illustrating an example of an MBS channel configuration in an MBS.

FIG. 5 includes a first diagram and a second diagram illustrating a first allocation of resources for physical DL shared channel (PDSCH) communication and a second allocation of resources for physical UL shared channel (PUSCH) communication, respectively, associated with a first type of RedCap in accordance with some aspects of the disclosure.

FIG. 6 includes a set of diagrams illustrating a plurality of options for a configuration of a CFR for broadcast or multicast (or an MBS) for wireless devices in an RRC inactive state in accordance with some aspects of the disclosure.

FIG. 7 is a call flow diagram illustrating a base station configuring a set of UEs associated with an MBS in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

FIG. 13 is a diagram illustrating an example of a hardware implementation for a network entity.

### DETAILED DESCRIPTION

A wireless communication system may support broadcast communication such as an MBS. In some aspects of wireless communication, wireless devices (e.g., UEs) in an RRC inactive or idle state may be configured to conserve power in association with an MBS. Some wireless devices (e.g., UEs) in the communication system may have reduced complexity and/or reduced power consumption based on supporting one or more reduced capabilities (e.g., which may be referred to as a RedCap UE). As an example, an nth type of RedCap device supporting a set of capabilities may be described in the following discussion as operating in one or more of an nth type of RedCap mode, an nth type of RedCap operation, or an nth type of RedCap mode of operation. An nth type of RedCap mode of operation, in some aspects, may be associated with an nth type of RedCap configuration or a set of nth type of RedCap parameters defining and/or specifying the capabilities supported in the nth type of RedCap mode of operation. A UE associated with, or implementing, an nth type of RedCap mode of operation may be referred to below as a RedCap UE generally, or more specifically as an nth type RedCap UE.

In some aspects, a RedCap device (or RedCap UE) may support (or a RedCap configuration may define and/or specify) a (maximum) baseband (BB) bandwidth (BW) for PDSCH and PUSCH and a (maximum) RF BW. For example, a first type of RedCap UE may support a (maximum) BB BW for PDSCH and PUSCH of 5 MHZ while supporting a (maximum) RF BW of 20 MHz. In some aspects, the maximum BB BW and/or RF BW may be indicated based on resource blocks (RBs) or Physical RBs (PRBs), e.g., a maximum BB BW may be defined and/or specified as one of 23-27 RBs (e.g., 25 RBs) associated with a 15 kHz SCS or one of 11-13 RBs (e.g., 12 RBs) associated with a 30 kHz SCS (for a total BB BW of approximately 5 MHz). Additional types of RedCap UEs may support different maximum BB BWs and different RF BWs. Different types of RedCap UEs may further be associated with additional parameters to reduce power associated with broadcast or multicast communication (or MBS) in an RRC inactive state that may be different for different types of RedCap UEs.

Various aspects of the disclosure relate generally to an MBS configuration for an enhanced RedCap device (eRedCap device or eRedCap UE) for an RRC idle or inactive state and supporting a first capability having a first maximum bandwidth that is different from a second capability having a second maximum bandwidth that is greater than the first maximum bandwidth. The MBS configuration for the eRedCap may allow for MBS reception in association with an additional complexity reduction beyond a complexity reduction associated with other RedCap capabilities. Some aspects more specifically relate to configuring a CFR (and/or other parameters) associated with the MBS configuration for the eRedCap devices. In some aspects, a base station may transmit, and a UE (e.g., an eRedCap UE) may receive, an indication of a CFR (or additional parameters) associated with at least one of an MCCH or an MTCH for a plurality of RedCap (or eRedCap) UEs in one of an inactive or idle state supporting the first capability. The base station may then transmit, and the UE may monitor for, a transmission or communication via the CFR indicated in the first indication for at least one of broadcast traffic or multicast traffic.

Particular aspects of the subject matter described in this disclosure can be implemented to realize one or more of the following potential advantages. The MBS configuration for the RedCap devices (or eRedCap devices) for an RRC idle or inactive state and supporting a first capability may improve complexity reduction associated with multicast or broadcast for the eRedCap UE in one of an RRC idle or inactive state for multicast or broadcast communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

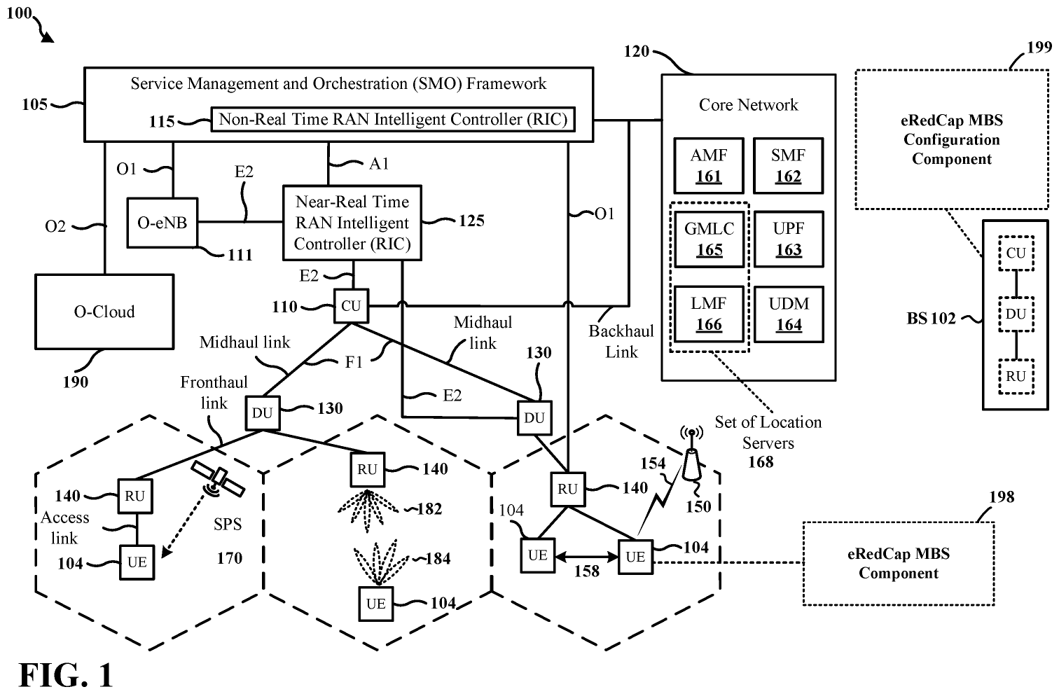

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

The wireless communication systems may support broadcast communication such as MBS. Referring again to FIG. 1, in certain aspects, the UE 104 may have an eRedCap MBS component 198 that may be configured to receive a first indication of a CFR associated with at least one of an MCCH or an MTCH for a plurality of RedCap UEs in one of a connected, inactive, or idle state supporting a first capability having a first maximum bandwidth that is different from a second capability having a second maximum bandwidth that is greater than the first maximum bandwidth. The eRedCap MBS component 198 may also be configured to monitor the CFR indicated in the first indication for at least one of broadcast traffic or multicast traffic. In certain aspects, the base station 102 may have an eRedCap MBS configuration component 199 that may be configured to output, for transmission to a plurality of RedCap UEs in one of an inactive or idle state supporting a first capability having a first maximum bandwidth that is different from a second capability having a second maximum bandwidth that is greater than the first maximum bandwidth, a first indication of a CFR associated with at least one of an MCCH or an MTCH for the plurality of RedCap UEs. The eRedCap MBS configuration component 199 may also be configured to output, for transmission to the plurality of RedCap UEs, at least one of an MCCH communication or an MTCH communication via the CFR indicated in the first indication for at least one of broadcast traffic or multicast traffic. While aspects of the following description may describe an application associated with MBS for RedCap UEs in an idle or inactive state (e.g., RRC inactive) in 5G NR, the concepts described herein may be applicable to other similar areas such as MBS for RedCap in other states.

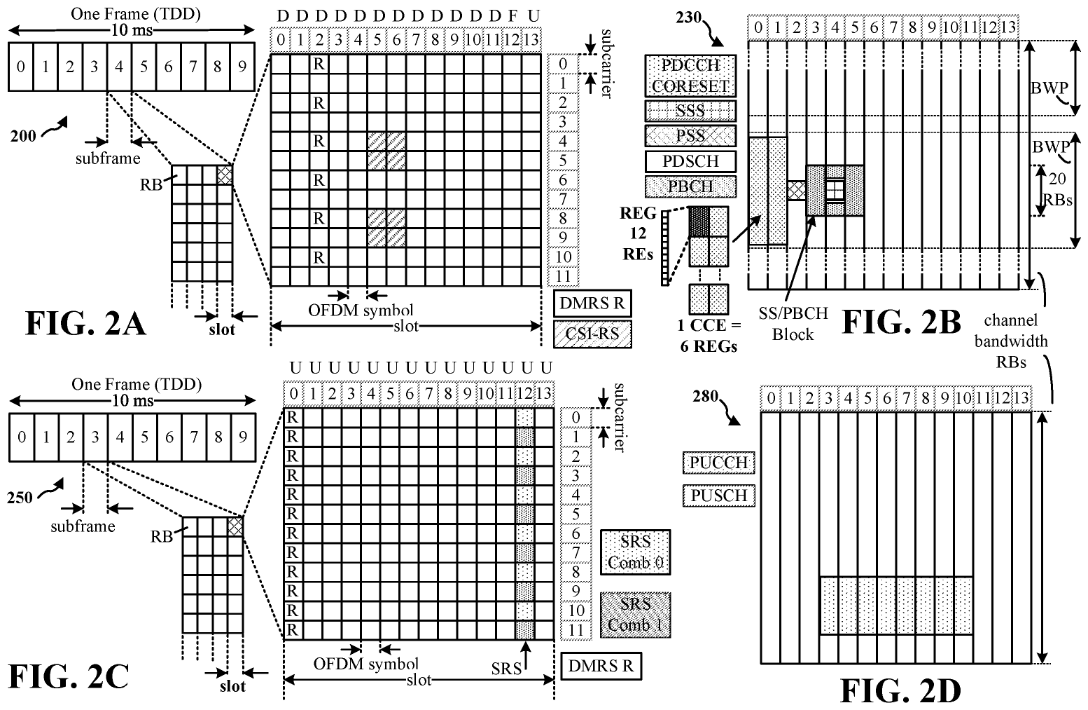

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes an RB (also referred to as PRBs) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

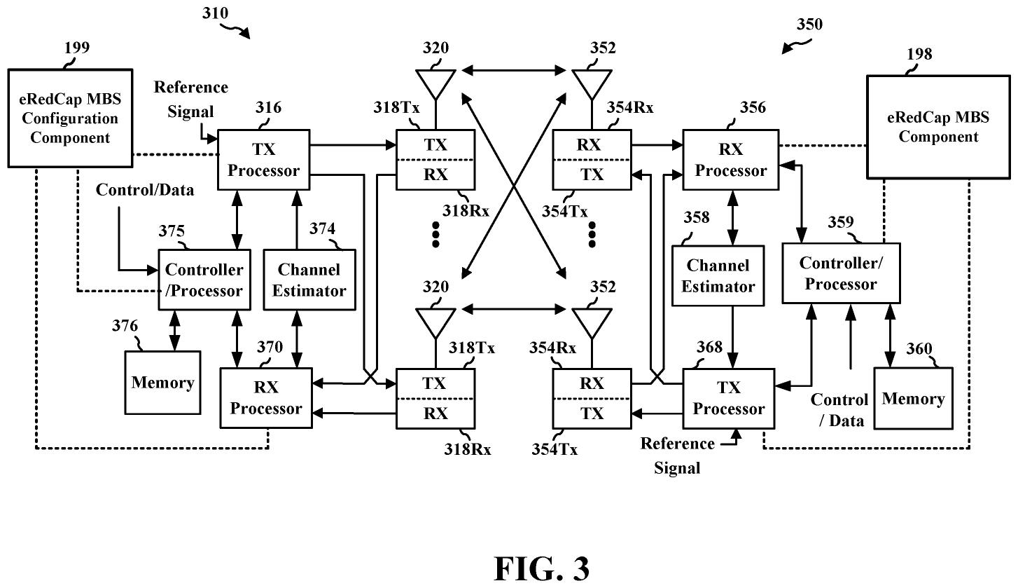

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the eRedCap MBS component 198 of FIG. 1.

At least one of the TX processor 316, the RX processor 370, and the controller/processor 375 may be configured to perform aspects in connection with the eRedCap MBS configuration component 199 of FIG. 1.

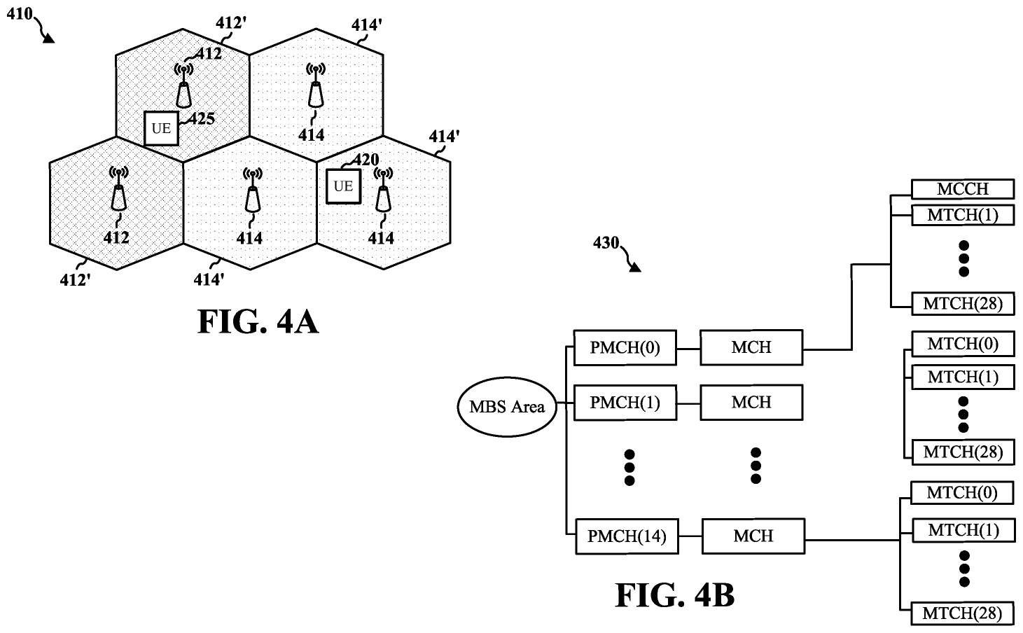

Some wireless communication systems may support broadcast communication, such as MBS. FIG. 4A is a diagram 410 illustrating an example of MBS areas in an access network. The base stations 412 (or TRP) in cells 412′ may form a first MBS area and the base stations 414 in cells 414′ may form a second MBS area. The base stations 412 and 414 may each be associated with other MBS areas. A cell within an MBS area may be designated a reserved cell. Reserved cells may not provide multicast/broadcast content, but may be time-synchronized to the cells 412′, 414′ and may have restricted power on MBS resources in order to limit interference to the MBS areas. Each base station in an MBS area synchronously transmits the same MBS control information and data. Each area may support broadcast, multicast, and unicast services. A unicast service is a service intended for a specific user, e.g., a voice call to a particular UE. A multicast service is a service that may be received by a group of users and may also be referred to as a groupcast, e.g., a subscription video service. A broadcast service is a service that may be received by any user within the coverage area, e.g., a news broadcast. Referring to FIG. 4A, the first MBS area may support a first MBS broadcast service, such as by providing a particular news broadcast to UE 425. The second MBS area may support a second MBS broadcast service, such as by providing a different news broadcast to UE 420.

FIG. 4B is a diagram 430 illustrating an example of an MBS channel configuration in an MBS. As shown in FIG. 4B, each MBS area supports one or more physical multicast channels (PMCH) (e.g., 15 PMCHs). Each PMCH corresponds to an MCH. Each MCH can multiplex a plurality (e.g., 29) of multicast logical channels. Each MBS area may have one multicast control channel (MCCH). As such, one MCH may multiplex one MCCH and a plurality of multicast traffic channels (MTCHs) and the remaining MCHs may multiplex a plurality of MTCHs.

A UE can camp on a cell to discover the availability of MBS service access and a corresponding access stratum configuration. Initially, the UE may acquire an SIB that includes information that enables the UE to acquire an MBS area configuration message on an MCCH. Subsequently, based on the MBS area configuration message, the UE may acquire an MCH Scheduling Information (MSI) medium access control-control element (MAC-CE). The SIB may include an MBS area identifier of each MBS area supported by the cell and information for acquiring the MCCH. There may be one MBS area configuration message for each MBS area. The MBS area configuration message may indicate a temporary mobile group identity (TMGI) and an optional session identifier of each MTCH identified by a logical channel identifier within the PMCH and allocated resources in time and/or frequency for each PMCH of the MBS area. A particular TMGI identifies a particular service of available MBS services.

In some aspects of wireless communication, wireless devices (e.g., UEs) in an RRC inactive (or idle) state may be configured to conserve power in association with an MBS. The wireless devices (e.g., UEs) in an RRC inactive state, in some aspects, may have reduced complexity and/or reduced power consumption and may support one of a plurality of types of reduced capabilities (RedCap). An n^{th} type of RedCap supporting a set of capabilities may be described in the following discussion as one or more of an n^{th} type of RedCap mode, an n^{th} type of RedCap operation, or an n^{th} type of RedCap mode of operation. An n^{th} type of RedCap mode of operation, in some aspects, may be associated with an n^{th} type of RedCap configuration or a set of n^{th} type of RedCap parameters defining and/or specifying the capabilities supported in the n^{th} type of RedCap mode of operation. A UE associated with, or implementing, an n^{th} type of RedCap mode of operation may be referred to below as a RedCap UE generally or specifically as an n^{th} type RedCap UE.

In some aspects, a RedCap device may support (or a RedCap configuration may define and/or specify) a (maximum) BB BW for PDSCH and PUSCH and a (maximum) RF BW. For example, a first type of RedCap device may support a (maximum) BB BW for PDSCH and PUSCH of 5 MHz while supporting a (maximum) RF BW of 20 MHZ. In some aspects, the maximum BB BW and/or RF BW may be specified based on RBs or PRBs, e.g., a maximum BB BW may be defined and/or specified as one of 23-27 RBs (e.g., 25 RBs) associated with a 15 kHz SCS or one of 11-13 RBs (e.g., 12 RBs) associated with a 30 kHz SCS (for a total BB BW of approximately 5 MHz). Additional types of RedCap may support different maximum BB BWs and different RF BWs. Different types of reduced capabilities or RedCap devices may further be associated with additional parameters to reduce power associated with broadcast or multicast communication (or MBS) in an RRC inactive state that may be different for different types of RedCap devices.

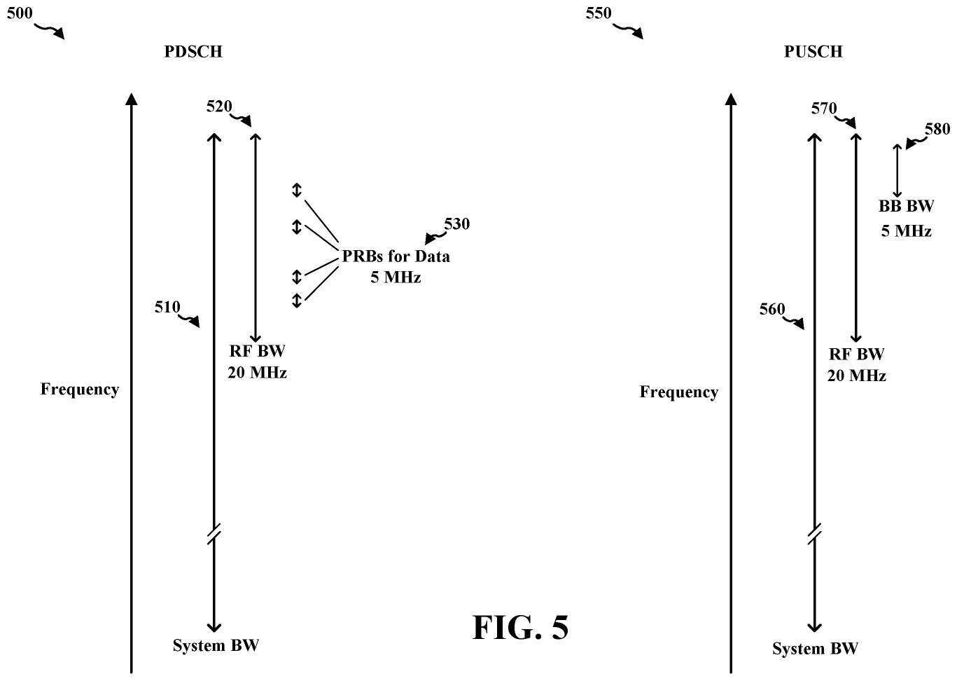

FIG. 5 includes a first diagram 500 and a second diagram 550 illustrating a first allocation of resources for PDSCH communication and a second allocation of resources for PUSCH communication, respectively, associated with a first type of reduced baseband bandwidth reduction for a RedCap UE in accordance with some aspects of the disclosure. The first diagram 500 illustrates that the first type of RedCap UE (e.g., a UE implementing a first type of RedCap) may be able to receive, via a 20 MHz RF BW 520 within a larger system BW 510, control information (e.g., a DCI) scheduling a unicast PDSCH. The scheduled PDSCH, in some aspects, may be scheduled via a set of PRBs 530 (or RBs) that span less than 5 MHZ (e.g., include a number of RBs that is no more than 1-13 RBs or 1-27 RBs associated with an SCS of 30 kHz or 15 kHz, respectively) in a particular slot.

The second diagram 550 illustrates that, in some aspects, the first type of RedCap UE may receive a configured grant or an UL grant for PUSCH with a BB BW 580 spanning up to 5 MHz within a RF BW 570 that is, in turn, within a larger system BW 560. The grant for the PUSCH may be transmitted by a network device, and received at a RedCap UE, via one or more of a PUCCH, a random access response (RAR), or DCI (e.g., DCI scrambled by a temporary cell RNTI (a temporary C-RNTI or TC-RNTI) indicating a temporary (16-bit) identity that may be used by a MAC entity during random access with a Msg3 PUSCH resource allocation). The (up to) 5 MHZ BB BW 580 for PUSCH may, in some aspects, be allocated per slot or per hop. While using the example of a first type of reduced capability (e.g., a first configuration associated with a first type of RedCap operation or mode) a maximum RF BW of 20 MHz and a maximum BB BW of 5 MHZ, the maximum BW for one or more of the BB or the RF may be different for the first type of reduced capability or for a different type of reduced capability.

In some aspects associated with a cell supporting multiple types of RedCap UEs, an initial BWP may be configured to support communication with devices of different capabilities, such as RedCap UEs and non-RedCap UEs. The initial BWP (e.g., which may include an initial downlink BWP) may be used by the network to transmit information for multiple types of UEs including different types of RedCap UEs. In some aspects, a SIB1 or other system information (OSI) (e.g. via PDSCH) PDSCH may carry information for RedCap UEs and for non-RedCap UEs, as well as for multiple types of RedCap UE with a reduced (e.g., <5 MHZ) maximum bandwidth. In some aspects, the scheduling of SIB1 and/or OSI (via PDSCH) may be allowed to be larger than 5 MHZ (e.g., may span more than 5 MHz of frequency resource as for a different type of RedCap UE or non-RedCap UE). In some aspects, a paging message or paging channel (e.g., via PDSCH) may be allowed to be larger than 5 MHz even for transmission to allow scheduling of paging PDSCH to be larger than 5 MHZ. In some aspects, a RAR (e.g., Msg2) may be allowed to be transmitted via a number of unicast PRBs (in a PDSCH) that is larger than the maximum number of unicast PRBs that the particular type of RedCap UE supports for processing per slot of PDSCH. Accordingly, when the scheduling of RAR PDSCH is within the maximum number of unicast PRBs that the particular type of RedCap UE is able to process per slot of PDSCH, a known time (e.g., a time applied for non-RedCap UEs) between RAR reception and Msg3 transmission (not smaller than N_{T,1}+N_{T,2}+0.5 ms) may be applied. However, when the scheduling of the RAR PDSCH is larger than the maximum number of unicast PRBs that the particular type of RedCap UE supports per slot, the particular type of RedCap UE may receive the RAR and transmit a corresponding Msg3 if the TDRA for Msg3 in the UL grant in the RAR indicates that the time between the RAR reception and the Msg3 transmission is not smaller than N_{T,1}+N_{T,2}+0.5+X ms, where X may be determined based on relevant factors. If the UL grant in the RAR indicates that the time between the RAR reception and the Msg3 transmission is smaller than N_{T,1}+N_{T,2}+0.5+X ms, the UE behavior, in some aspects, may be determined based on a UE implementation.

For UEs in an RRC idle, RRC inactive, or RRC connected state, in some aspects, a broadcast common frequency resource (CFR) for MCCH or MTCH may be configured, for example, by SIB20 or MCCH. A dynamic grant group common (GC)-PDCCH or GC-PDSCH for MCCH may be associated with a MCCH-RNTI, while for MTCH, a GC-PDCCH or GC-PDSCH may be associated with one or more G-RNTI. In some aspects, a DCI format (e.g., a DCI format 4_0) associated with the GC-PDCCH may be configured in a common search space parameter (e.g., a Type0B-CSS). Changes for MCCH configuration, in some aspects, may be indicated in a same DCI for the MCCH. In some aspects, a broadcast MTCH may be scheduled semi-statically or dynamically for slot-level repetition. In some aspects, an MCCH and a PBCH may be frequency division multiplexed for broadcast UEs (e.g., UEs associated with a broadcast).

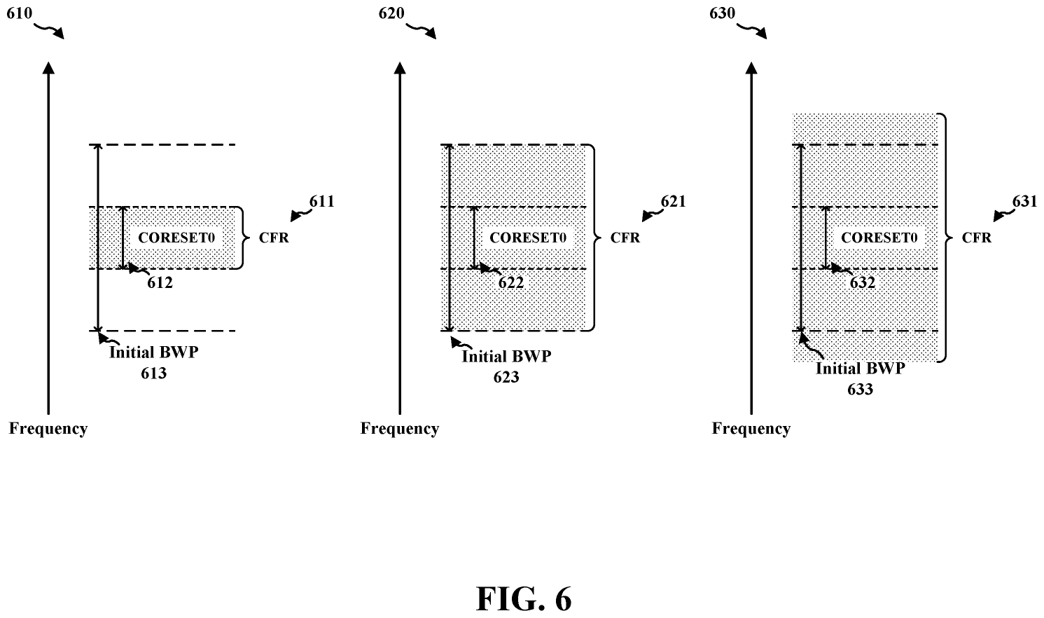

FIG. 6 includes a set of diagrams (e.g., diagram 610, diagram 620, and diagram 630) illustrating a plurality of options for a configuration of a CFR for broadcast or multicast (or MBS) for wireless devices in an RRC inactive state in accordance with some aspects of the disclosure. In some aspects, a CFR for MBS (e.g., for MCCH and/or MTCH) may be defined (or configured) by a common information element (e.g., locationAndBandwidth) associated with broadcast or multicast communication. Diagram 610 illustrates a first case for which a CFR 611 has a same BW as a CORESET0 612, but not a same BW as an initial BW 613 (e.g., initial downlink BWP configured by SIB1). Diagram 620 illustrates a second case for which a CFR 621 has a same BW as an initial BW 623, that is greater than a BW of a CORESET0 622. Diagram 630 illustrates a third case for which a CFR 631 has a greater BW than both a CORESET0 632, and an initial BW 633 (e.g., initial downlink BWP).

In some aspects, the CFR for MBS broadcast (and/or multicast) may fully contain the CORESET0 (which may alternatively be referred to as CORESET #0) (e.g., span a bandwidth that includes the frequency resources for the CORESET #0) and may have the same CP and SCS as CORESET0 and/or the initial BWP. In additional to the CFR BW size, the CFR for MCCH/MTCH (e.g., CFR 611, 621, or 631) may also include a first CFR for MCCH configured via SIB20 and a second CFR for MTCH configured via the MCCH (e.g., via a PDCCH-config and/or PDSCH-config for MTCH). If the CFR for the MTCH is not configured via the MCCH, the PDCCH-config and/or the PDSCH-config for MCCH configured via a different SIB may be reused for the MTCH, in some aspects.

A PDCCH configuration for MCCH and/or MTCH, in some aspects, may be associated with a CORESET, a search space, or DCI. The PDCCH configuration for MCCH or MTCH may be included in an information element (IE) associated with the CORESET, the search space, or the DCI. For example, a CORESET may be associated with, or include, an IE providing, specifying, or defining the PDCCH configuration for MCCH or MTCH in a first IE (e.g., PDCCH-Config-MCCH) or a second IE (e.g., PDCCH-Config-MTCH), respectively. In some aspects, UEs may be configured with up to 2 CORESETS for MCCH and/or MTCH. A CORESET for MCCH and/or MTCH, in some aspects, may be a CORESET0 configured via a first IE for configuring a common CORESET (e.g., a common ControlResourceSet IE). A UE, in some aspects, may be configured with a CORESET having a larger BW than CORESET0 for MCCH and/or MTCH, e.g., if no CORESET is configured by commonControlResourceSet. In some aspects, CORESET0 is used by default if the CFR is the initial BWP and another CORESET is not configured. An initializing scrambling sequence generator of GC-PDCCH and for a DMRS of GC-PDCCH, in some aspects, may be configured in, or via, the CORESET.

In some aspects, the PDCCH for MCCH and/or MTCH may be configured in association with a search space (e.g., a SearchSpaceBroadcast IE) associated with an MBS, e.g., via a PDCCH-ConfigCommon for MCCH and/or MTCH. In some aspects, a first common search space (CSS) type may be configured for MCCH and MTCH. For a primary cell (Pcell), a second type (e.g., a Type0B-PDCCH) of CSS set may be configured for MCCH and MTCH, e.g., via a SIB (e.g., “SIBx”) and/or MCCH. For a secondary cell (Scell) associated with a connected UE (e.g., a UE in an RRC connected mode), a third type (e.g., Type3-PDCCH) of CSS set may be configured for MCCH and MTCH, e.g., via unicast RRC. The search space associated with the MBS (e.g., the SearchSpaceBroadcast IE), in some aspects, may further be associated with (e.g., may include) DCI. In some aspects, the DCI may indicate the PDCCH for the MCCH and/or MTCH. The DCI indicating the PDCCH for the MCCH and/or MTCH, in some aspects, may be transmitted via the CSS and may use an MBS-specific format and/or may be scrambled by an MBS-specific RNTI (e.g., a G-RNTI, a GC-RNTI, a TG-RNTI, etc.). The MBS-specific format may be based on a known format (e.g., may include the same types of information using the same bits) or may be a newly-defined DCI format or type.

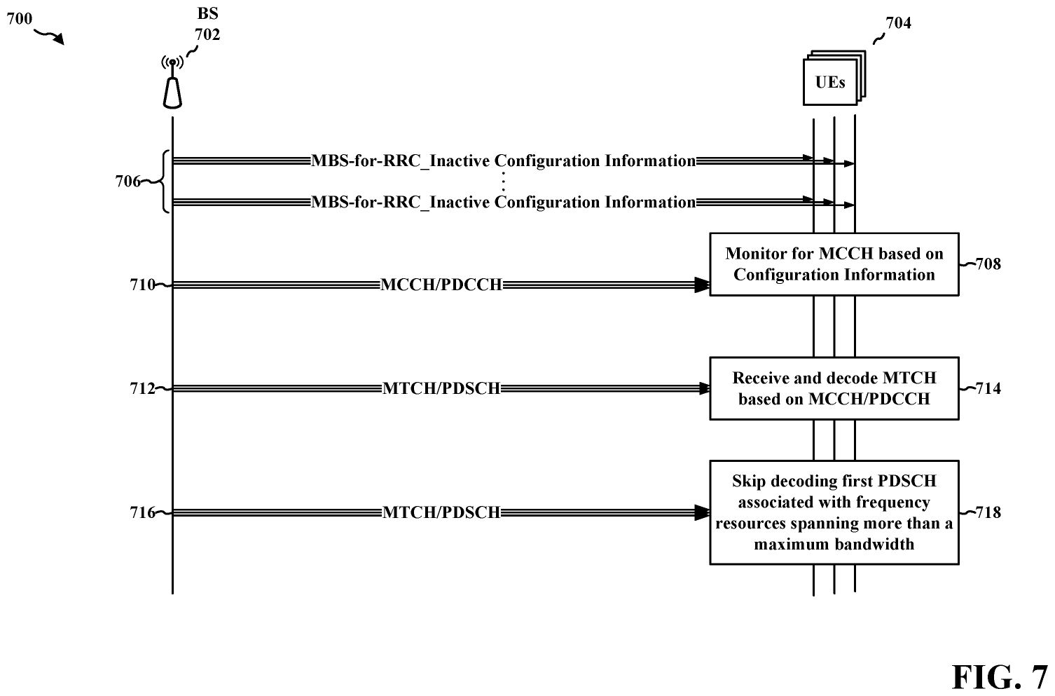

FIG. 7 is a call flow diagram 700 illustrating a base station configuring a set of UEs associated with an MBS in accordance with some aspects of the disclosure. The base station 702 (e.g., as an example of a network device or network node that may include one or more components of a disaggregated base station) may transmit, and the set of UEs 704 (e.g., as an example of a wireless device) may receive, a set of one or more messages 706 that include configuration information for at least one of multicast or broadcast resources for an MBS. In order to transmit the set of one or more messages 706, the base station 702 may, in some aspects, include a first component generating the set of one or more messages 706 and outputting the set of one or more messages 706 for transmission by a second component of the base station.

The set of UEs 704, in some aspects, may be in one of an inactive or idle state (e.g., an RRC inactive state). The set of UEs 704, in some aspects, may be a set of first type RedCap UEs (e.g., a plurality of UEs implementing the first type of RedCap) supporting a first capability having a first maximum bandwidth (e.g., 5 MHZ) that is different from a second capability having a second maximum bandwidth (e.g., 100 MHz or 20 MHZ) that is greater than the first maximum bandwidth. The configuration information, in some aspects, may include a first indication of a first CFR associated with at least one of an MCCH or an MTCH for the set of the first type of RedCap UEs. The first indication, in some aspects, may be included in an SIB. The first CFR, in some aspects, may be based on the first capability.

The second capability may be a non-RedCap (e.g., alternatively referred to as a full, or standard, capability) and a second CFR for an MBS may be specified for a set of non-RedCap UEs (not shown). In some aspects, the second capability may be a second type of RedCap supporting the second capability. The set of one or more messages 706 may include an indication of different CFRs for different types of RedCap UEs supporting the first capability. For example, different types of methods of complexity reduction (e.g., using a reduced number of total PRBs for PDSCH or a reduced BB BW for PUSCH described in relation to FIG. 5) may be employed in conjunction with the first capability.

In some aspects, the first CFR may be associated with at least one of the MCCH or the MTCH for multiple types of RedCap UEs. In some aspects, the multiple types of RedCap UEs may be defined (or distinguished) based on at least one different value in a set of parameters associated with the type of RedCap (or type of RedCap UE) while a same CFR may be shared based on supporting a same maximum bandwidth (e.g., supporting the first capability). For example, a first type of RedCap (e.g., a first type of enhanced RedCap, or eRedCap, defined for Rel 18) may support a same maximum bandwidth as a second type of RedCap (e.g., a second type of eRedCap defined for Rel 18 or a second type of RedCap defined for Rel 17) for reducing complexity.

The first CFR, in some aspects, may be different from a second CFR associated with at least one of an MCCH or an MTCH for one or more RedCap UEs (e.g., a second set of RedCap UEs) supporting a third capability having a third maximum bandwidth that is greater than the first maximum bandwidth and less than the second maximum bandwidth.

The set of one or more messages 706, in some aspects, may further include a first MCCH configuration for a first type of RedCap UE that is different from a second MCCH configuration for a second type of RedCap UE. The first MCCH configuration, in some aspects, specifies at least one of a first periodicity of MCCH resources or a first offset associated with the MCCH that is different from a second periodicity of MCCH resources or a second offset associated specified by the second MCCH configuration. In some aspects, the set of one or more messages 706, may include a first MTCH configuration for a first type of RedCap UE that is different from a second MTCH configuration for a second type of RedCap UE. The first MTCH configuration, in some aspects, may include (an additional indication of) at least one of a first rate matching (RM), a first limited buffer RM (LBRM), or a first set of reference signal (RS) configurations associated with the MTCH that is different from a second RM, a second LBRM, or a second set of RS configurations associated with the second MTCH configuration.

In some aspects, the set of one or more messages 706 may include a first discontinuous reception (DRX) configuration (e.g., associated with one or more DRX-Config elements) associated with a first type of RedCap UE that is different from a second DRX configuration for a second type of RedCap UE. For example, the first DRX configuration may be associated with one or more of a first period for a DRX cycle (e.g., a cycle including an ON/awake/active state and an OFF/asleep/inactive state), a first duration for an ON, or awake, state (e.g., drx-onDuration), a first DRX inactivity time (e.g., drx-InactivityTimer), or other first parameter values for other DRX parameters (e.g., drx-ShortCycle, drx-ShortCycleTimer, drx-HARQ-RTT-TimerDL, drx-HARQ-RTT-TimerUL, drx-RetransmissionTimerDL, drx-RetransmissionTimerUL, drx-SlotOffset, etc.). The second DRX configuration, in some aspects, may be associated with one or more of a second period for a DRX cycle, a second duration for an ON, or awake, state, a second DRX inactivity time, or other second parameter values for other DRX parameters. In some aspects, the first DRX configuration and the second DRX configuration may include one of a same set of elements with one or more different associated values or a different set of elements with associated values for overlapping elements that may be the same or different.

The set of one or more messages 706, in some aspects, may include a configuration of a first list of neighbor cells (e.g., an mbs-NeighbourCellList IE) with ongoing multicast or broadcast communication sessions associated with a first type of RedCap UE that is different from a second list of neighbor cells with ongoing multicast or broadcast communication sessions associated with a second type of RedCap UE. The set of one or more messages 706, in some aspects, may include a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. In some aspects, the set of one or more messages 706 may include a third indication of a first MTCH neighbor cell configuration (e.g., mich-NeighbourCell IE) for the first G-RNTI that is different from a second MTCH neighbor cell configuration for the second G-RNTI.

Based on the set of one or more messages 706, the UEs in the set of UEs 704 may monitor, at 708, for MCCH (or PDCCH). Monitoring for the MCCH (or PDCCH), in some aspects, may include monitoring the configured first CFR. The monitoring at 708, in some aspects, may be based on the first DRX configuration. In some aspects, the monitoring at 708 may be limited to MTCH (or PDSCH) occasions spanning no more than 5 MHZ (e.g., limited to a span of 5 MHZ).

While the set of UEs 704 monitors for MCCH (or PDCCH), the base station 702, in some aspects, may transmit, and the set of UEs 704 may receive, MCCH (or PDCCH) 710. The MCCH (or PDCCH) 710, in some aspects, may relate to one or more multicast or broadcast transmissions (e.g., may be associated with a G-RNTI or an MCCH-RNTI associated with an MTCH and/or a PDSCH communication) for the first type of RedCap UE or for one of the non-RedCap UE supporting the second maximum bandwidth or the second type of RedCap UE supporting one of the second maximum bandwidth or the third maximum bandwidth. For example, the MCCH (or PDCCH) 710 may schedule MTCH (or PDSCH) communication 712 via a set of frequency resources (e.g., indicated in a first frequency domain resource allocation (FDRA)) spanning a set of frequency resources less than the first maximum bandwidth.

In some aspects, the base station 702 may transmit, and the set of UEs 704 may receive (and decode) at 714, the MTCH (or PDSCH) communication 712 for the plurality of RedCap UEs (e.g., the first type of RedCap UEs) scheduled by the MCCH (or PDCCH) 710. In some aspects, the MTCH (or PDSCH) communication 712 for the plurality of RedCap UEs (e.g., the first type of RedCap UEs) may be associated with a set of PRBs spanning fewer than 5 MHZ (e.g., a group of contiguous, or non-contiguous, PRBs that spans fewer than 5 MHZ). The set of PRBs (e.g., the PRBs 530 or the BB BW 580), in some aspects may be distributed within a larger RF BW (e.g., the RF BW 520 or 570) supported by the set of UEs 704 (or supported by the first type of RedCap UE).

Additionally, or alternatively, the MCCH (or PDCCH) 710 may schedule MTCH (or PDSCH) communication 716 via a set of frequency resources (e.g., indicated in a second FDRA) spanning a set of frequency resources greater than the first maximum bandwidth. Based on the scheduled MTCH (or PDSCH) communication 716 having frequency resources spanning more than the first maximum bandwidth, the set of UEs 704 may, at 718, skip decoding the MTCH (or PDSCH) communication 716.

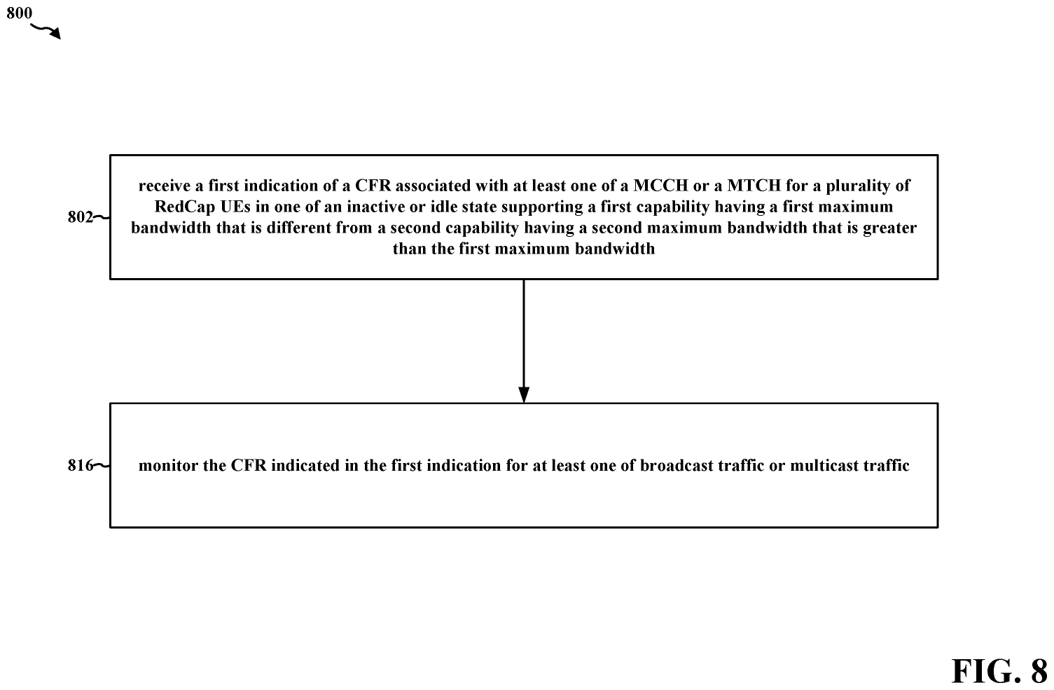

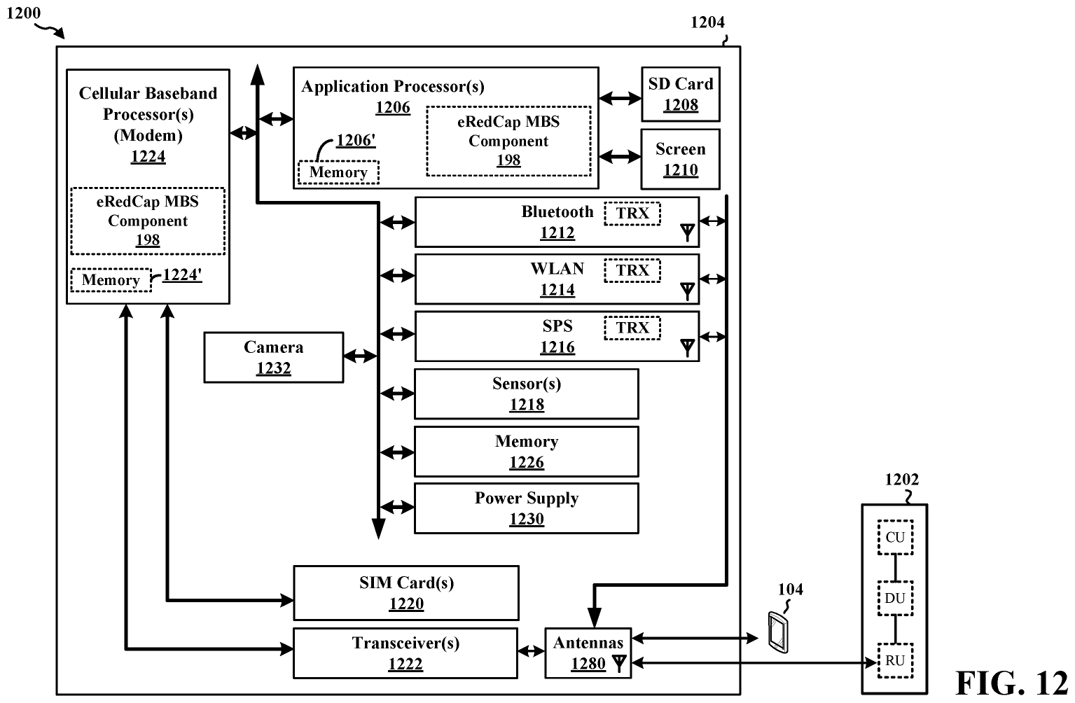

FIG. 8 is a flowchart 800 of a method of wireless communication. The method may be performed by a wireless device such as a UE (e.g., the UE 104, 420, 425; a UE in the set of UEs 704; the apparatus 1204). At 802, the UE may receive a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth. For example, 802 may be performed by application processor 1206, cellular baseband processor 1224, transceiver(s) 1222, antenna(s) 1280, and/or eRedCap MBS component 198 of FIG. 12. The UE (and the other UEs of the plurality of RedCap UEs), in some aspects, may be a first type RedCap UE (e.g., a UE implementing the first type of RedCap) supporting a first capability having a first maximum bandwidth (e.g., 5 MHZ) that is different from a second capability having a second maximum bandwidth (e.g., 100 MHz or 20 MHZ) that is greater than the first maximum bandwidth. The first indication, in some aspects, may be included in an SIB. The first CFR, in some aspects, may be based on the first capability. The CFR, may be a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

The second capability may be a non-RedCap (e.g., alternatively referred to as a full, or standard, capability) and a second CFR for an MBS may be specified for a set of non-RedCap UEs. In some aspects, the second capability may be a second type of RedCap supporting the second capability. The first indication may be included in a set of indications of the different CFRs for different types of RedCap UEs supporting the first capability. For example, different types of methods of complexity reduction (e.g., using a reduced number of total PRBs for PDSCH or a reduced BB BW for PUSCH described in relation to FIG. 5) may be employed in conjunction with the first capability.

In some aspects, the first CFR may be associated with at least one of the MCCH or the MTCH for multiple types of RedCap UEs. In some aspects, the multiple types of RedCap UEs may be defined based on at least one different value in a set of parameters associated with the type of RedCap (or type of RedCap UE) while a same CFR may be shared based on supporting a same maximum bandwidth (e.g., supporting the first capability). For example, a first type of RedCap device (e.g., a first type of enhanced RedCap, or eRedCap device) may support a same maximum bandwidth as a second type of RedCap (e.g., a second type of eRedCap device or a second type of RedCap device) for reducing complexity.

The first CFR, in some aspects, may be different from a second CFR associated with at least one of an MCCH or an MTCH for one or more RedCap UEs (e.g., a second set of RedCap UEs) supporting a third capability having a third maximum bandwidth that is greater than the first maximum bandwidth and less than the second maximum bandwidth. For example, referring to FIG. 7, a UE in the set of UEs 704 may receive the set of one or more messages 706 that may include the first indication.

In some aspects, receiving the first indication of the CFR at 802 may include (or be associated with) receiving a first MCCH configuration for a first type of RedCap UE that is different from a second MCCH configuration for a second type of RedCap UE. The first MCCH configuration, in some aspects, may specify at least one of a first periodicity of MCCH resources or a first offset associated with the MCCH that may be different from a second periodicity of MCCH resources or a second offset associated specified by the second MCCH configuration. For example, referring to FIG. 7, a UE in the set of UEs 704 may receive the set of one or more messages 706 that may include the first MCCH configuration.

In some aspects, receiving the first indication of the CFR at 802 may include (or be associated with) receiving a first MTCH configuration for a first type of RedCap UE that is different from a second MTCH configuration for a second type of RedCap UE. The first MTCH configuration includes at least one of a first RM, a first LBRM, or a first set of RS configurations associated with the MTCH that is different from a second RM, a second LBRM, or a second set of RS configurations associated with the second MTCH configuration. For example, referring to FIG. 7, a UE in the set of UEs 704 may receive the set of one or more messages 706 that may include the first MTCH configuration.

Receiving the first indication of the CFR at 802, in some aspects, may include (or be associated with) receiving a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. Referring to FIG. 7, for example, a UE in the set of UEs 704 may receive the set of one or more messages 706 that may include the first list of neighbor cells.

In some aspects, receiving the first indication of the CFR at 802 may include (or be associated with) receiving a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. In some aspects, a PDSCH (or MTCH) communication scheduled by a PDCCH (or MCCH) associated with at least one of the G-RNTI or an MCCH-RNTI associated with the MTCH for the UE (or the plurality of RedCap UEs) may be associated with a set of PRBs spanning fewer than the first maximum bandwidth (e.g., 5 MHZ.) For example, referring to FIG. 7, a UE in the set of UEs 704 may receive the set of one or more messages 706 that may include the second indication.

Receiving the first indication of the CFR at 802, in some aspects, may include (or be associated with) receiving a third indication of a first MTCH neighbor cell configuration for the first G-RNTI that is different from a second MTCH neighbor cell configuration for the second G-RNTI. Referring to FIG. 7, for example, a UE in the set of UEs 704 may receive the set of one or more messages 706 that may include the third indication.

In some aspects, receiving the first indication of the CFR at 802 may include (or be associated with) receiving a first DRX configuration associated with a first type of RedCap UE that is different from a second DRX configuration for a second type of RedCap UE. Referring to FIG. 7, for example, a UE in the set of UEs 704 may receive the set of one or more messages 706 that may include the first DRX configuration.

At 816, the UE may monitor the CFR indicated in the first indication for at least one of broadcast traffic or multicast traffic. Monitoring the CFR at 816, in some aspects, may include skipping decoding of a PDSCH based on the PDSCH having frequency resources spanning more than the first maximum bandwidth. In some aspects, monitoring the CFR at 816 may include monitoring, based on the first DRX configuration, PDSCH occasions limited to a span of the first maximum bandwidth (e.g., 5 MHZ). For example, 816 may be performed by application processor 1206, cellular baseband processor 1224, transceiver(s) 1222, antenna(s) 1280, and/or eRedCap MBS component 198 of FIG. 12. Referring to FIG. 7, for example, a UE in the set of UEs 704 may monitor at 708 for the MCCH (or PDCCH) 710, may monitor (and may receive (and decode) at 714) for the MTCH (or PDSCH) communication 712, or may monitor for the MTCH (or PDSCH) communication 716 (and may skip decoding at 718). FIG. 8

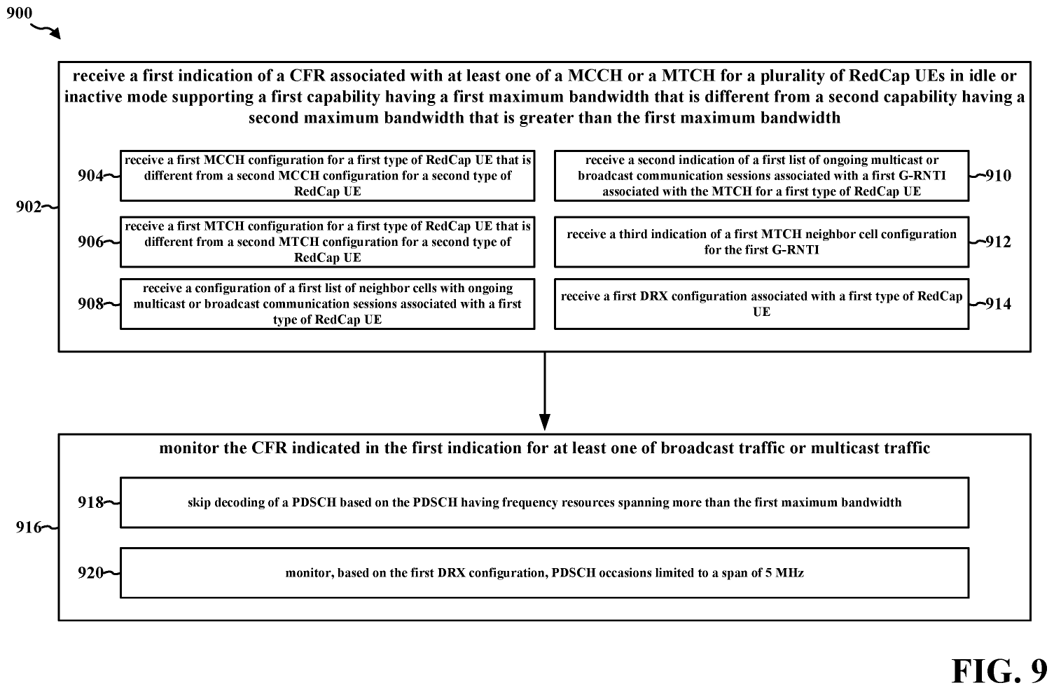

FIG. 9 is a flowchart 900 of a method of wireless communication. The method may be performed by a wireless device such as a UE (e.g., the UE 104, 420, 425; a UE in the set of UEs 704; the apparatus 1204). At 902, the UE may receive a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth. For example, 902 may be performed by application processor(s) 1206, cellular baseband processor(s) 1224, transceiver(s) 1222, antenna(s) 1280, and/or eRedCap MBS component 198 of FIG. 12. The UE (and the other UEs of the plurality of RedCap UEs), in some aspects, may be a first type RedCap UE (e.g., a UE implementing the first type of RedCap) supporting a first capability having a first maximum bandwidth (e.g., 5 MHZ) that is different from a second capability having a second maximum bandwidth (e.g., 100 MHz or 20 MHZ) that is greater than the first maximum bandwidth. The first indication, in some aspects, may be included in an SIB. The first CFR, in some aspects, may be based on the first capability. The CFR, may be a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

The second capability may be a non-RedCap (e.g., alternatively referred to as a full, or standard, capability) and a second CFR for an MBS may be specified for a set of non-RedCap UEs. In some aspects, the second capability may be a second type of RedCap supporting the second capability. The first indication may be included in a set of indications of the different CFRs for different types of RedCap UEs supporting the first capability. For example, different types of methods of complexity reduction (e.g., using a reduced number of total PRBs for PDSCH or a reduced BB BW for PUSCH described in relation to FIG. 5) may be employed in conjunction with the first capability.

In some aspects, the first CFR may be associated with at least one of the MCCH or the MTCH for multiple types of RedCap UEs. In some aspects, the multiple types of RedCap UEs may be defined based on at least one different value in a set of parameters associated with the type of RedCap (or type of RedCap UE) while a same CFR may be shared based on supporting a same maximum bandwidth (e.g., supporting the first capability). For example, a first type of RedCap (e.g., a first type of enhanced RedCap, or eRedCap device) may support a same maximum bandwidth as a second type of RedCap (e.g., a second type of eRedCap device or a second type of RedCap device) for reducing complexity.

The first CFR, in some aspects, may be different from a second CFR associated with at least one of an MCCH or an MTCH for one or more RedCap UEs (e.g., a second set of RedCap UEs) supporting a third capability having a third maximum bandwidth that is greater than the first maximum bandwidth and less than the second maximum bandwidth. For example, referring to FIG. 7, a UE in the set of UEs 704 may receive the set of one or more messages 706 that may include the first indication.

In some aspects, receiving the first indication of the CFR at 902 may include (or be associated with) receiving, at 904, a first MCCH configuration for a first type of RedCap UE that is different from a second MCCH configuration for a second type of RedCap UE. For example, 904 may be performed by application processor(s) 1206, cellular baseband processor(s) 1224, transceiver(s) 1222, antenna(s) 1280, and/or eRedCap MBS component 198 of FIG. 12. The first MCCH configuration, in some aspects, may specify at least one of a first periodicity of MCCH resources or a first offset associated with the MCCH that may be different from a second periodicity of MCCH resources or a second offset associated specified by the second MCCH configuration. For example, referring to FIG. 7, a UE in the set of UEs 704 may receive the set of one or more messages 706 that may include the first MCCH configuration.

In some aspects, receiving the first indication of the CFR at 902 may include (or be associated with) receiving, at 906, a first MTCH configuration for a first type of RedCap UE that is different from a second MTCH configuration for a second type of RedCap UE. For example, 906 may be performed by application processor(s) 1206, cellular baseband processor(s) 1224, transceiver(s) 1222, antenna(s) 1280, and/or eRedCap MBS component 198 of FIG. 12. The first MTCH configuration includes at least one of a first RM, a first LBRM, or a first set of RS configurations associated with the MTCH that is different from a second RM, a second LBRM, or a second set of RS configurations associated with the second MTCH configuration. For example, referring to FIG. 7, a UE in the set of UEs 704 may receive the set of one or more messages 706 that may include the first MTCH configuration.

Receiving the first indication of the CFR at 902, in some aspects, may include (or be associated with) receiving, at 908, a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. For example, 908 may be performed by application processor(s) 1206, cellular baseband processor(s) 1224, transceiver(s) 1222, antenna(s) 1280, and/or eRedCap MBS component 198 of FIG. 12. Referring to FIG. 7, for example, a UE in the set of UEs 704 may receive the set of one or more messages 706 that may include the first list of neighbor cells.

In some aspects, receiving the first indication of the CFR at 902 may include (or be associated with) receiving, at 910, a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. For example, 910 may be performed by application processor(s) 1206, cellular baseband processor(s) 1224, transceiver(s) 1222, antenna(s) 1280, and/or eRedCap MBS component 198 of FIG. 12. In some aspects, a PDSCH (or MTCH) communication scheduled by a PDCCH (or MCCH) associated with at least one of the G-RNTI or an MCCH-RNTI associated with the MTCH for the UE (or the plurality of RedCap UEs) may be associated with a set of PRBs spanning fewer than the first maximum bandwidth (e.g., 5 MHz.) For example, referring to FIG. 7, a UE in the set of UEs 704 may receive the set of one or more messages 706 that may include the second indication.

Receiving the first indication of the CFR at 902, in some aspects, may include (or be associated with) receiving, at 912, a third indication of a first MTCH neighbor cell configuration for the first G-RNTI that is different from a second MTCH neighbor cell configuration for the second G-RNTI. For example, 912 may be performed by application processor(s) 1206, cellular baseband processor(s) 1224, transceiver(s) 1222, antenna(s) 1280, and/or eRedCap MBS component 198 of FIG. 12. Referring to FIG. 7, for example, a UE in the set of UEs 704 may receive the set of one or more messages 706 that may include the third indication.

In some aspects, receiving the first indication of the CFR at 902 may include (or be associated with) receiving, at 914, a first DRX configuration associated with a first type of RedCap UE that is different from a second DRX configuration for a second type of RedCap UE. For example, 914 may be performed by application processor(s) 1206, cellular baseband processor(s) 1224, transceiver(s) 1222, antenna(s) 1280, and/or eRedCap MBS component 198 of FIG. 12. Referring to FIG. 7, for example, a UE in the set of UEs 704 may receive the set of one or more messages 706 that may include the first DRX configuration.

At 916, the UE may monitor the CFR indicated in the first indication for at least one of broadcast traffic or multicast traffic. Monitoring the CFR at 916, in some aspects, may include skipping, at 918, decoding of a PDSCH based on the PDSCH having frequency resources spanning more than the first maximum bandwidth. In some aspects, monitoring the CFR at 916 may include monitoring, at 920, based on the first DRX configuration, PDSCH occasions limited to a span of the first maximum bandwidth (e.g., 5 MHZ). For example, 916, 918, and 920 may be performed by application processor(s) 1206, cellular baseband processor(s) 1224, transceiver(s) 1222, antenna(s) 1280, and/or eRedCap MBS component 198 of FIG. 12. Referring to FIG. 7, for example, a UE in the set of UEs 704 may monitor at 708 for the MCCH (or PDCCH) 710, may monitor (and may receive (and decode) at 714) for the MTCH (or PDSCH) communication 712, or may monitor for the MTCH (or PDSCH) communication 716 (and may skip decoding at 718).

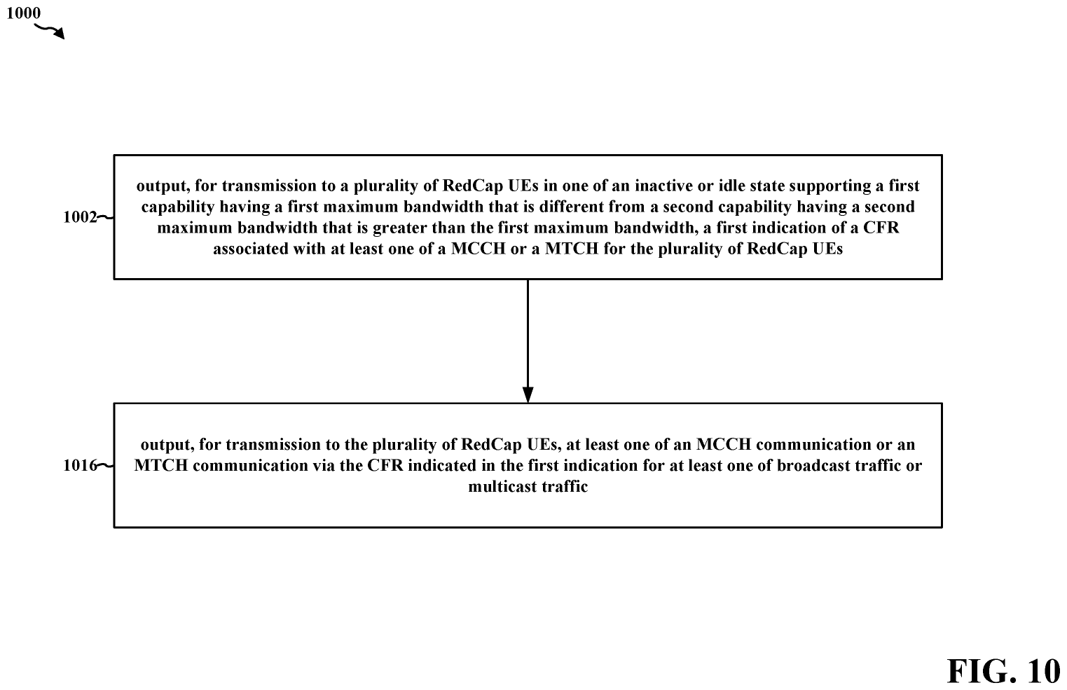

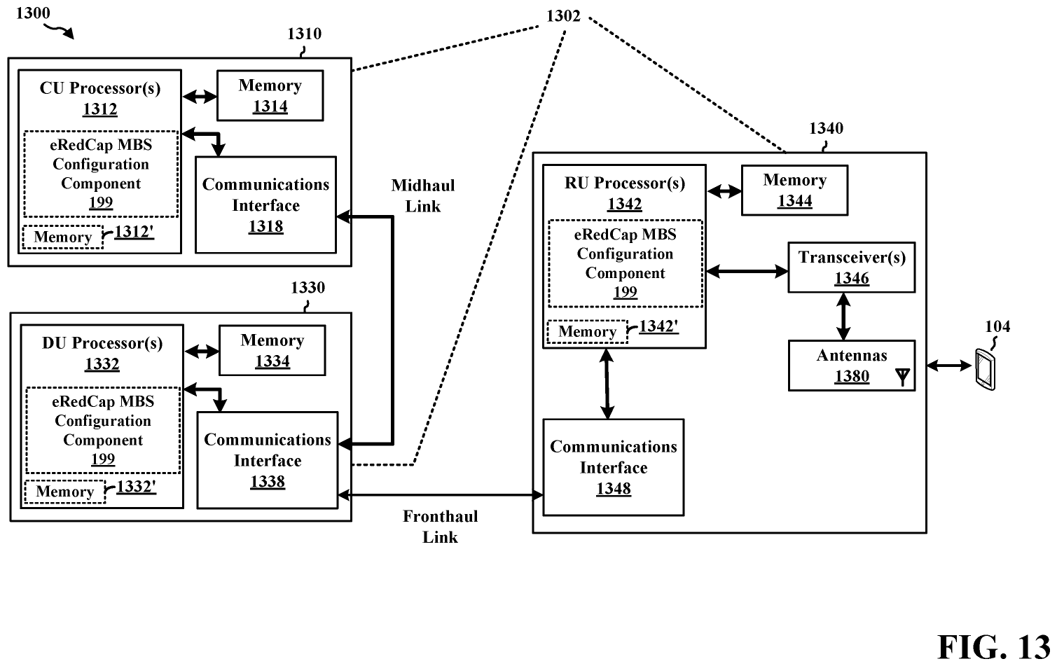

FIG. 10 is a flowchart 1000 of a method of wireless communication. The method may be performed by a network node or network device such as a base station (e.g., the base station 102, 412, 414, 702; the network entity 1202, 1302). At 1002, the base station may output (for transmission to a plurality of RedCap UEs in one of an inactive or idle state supporting a first capability having a first maximum bandwidth that is different from a second capability having a second maximum bandwidth that is greater than the first maximum bandwidth), and/or may transmit to the plurality of RedCap UEs, a first indication of a CFR associated with at least one of an MCCH or an MTCH for the plurality of RedCap UEs. For example, 1002 may be performed by CU processor(s) 1312, DU processor(s) 1332, RU processor(s) 1342, transceiver(s) 1346, antenna(s) 1380, and/or eRedCap MBS configuration component 199 of FIG. 13. The plurality of RedCap UEs, in some aspects, may be a first type RedCap UE (e.g., a UE implementing the first type of RedCap) supporting a first capability having a first maximum bandwidth (e.g., 5 MHz) that is different from a second capability having a second maximum bandwidth (e.g., 100 MHz or 20 MHZ) that is greater than the first maximum bandwidth. The first indication, in some aspects, may be included in an SIB. The first CFR, in some aspects, may be based on the first capability. The CFR, may be a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

The second capability may be a non-RedCap (e.g., or a full, or standard, capability) and a second CFR for an MBS may be specified for a set of non-RedCap UEs. In some aspects, the second capability may be a second type of RedCap supporting the second capability. The first indication may be included in a set of indications of the different CFRs for different types of RedCap UEs supporting the first capability. For example, different types of methods of complexity reduction (e.g., using a reduced number of total PRBs for PDSCH or a reduced BB BW for PUSCH described in relation to FIG. 5) may be employed in conjunction with the first capability.

In some aspects, the first CFR may be associated with at least one of the MCCH or the MTCH for multiple types of RedCap UEs. In some aspects, the multiple types of RedCap UEs may be defined based on at least one different value in a set of parameters associated with the type of RedCap (or type of RedCap UE) while a same CFR may be shared based on supporting a same maximum bandwidth (e.g., supporting the first capability). For example, a first type of RedCap (e.g., a first type of enhanced RedCap, or eRedCap device) may support a same maximum bandwidth as a second type of RedCap (e.g., a second type of eRedCap defined for Rel 18 or a second type of RedCap device) for reducing complexity.

The first CFR, in some aspects, may be different from a second CFR associated with at least one of an MCCH or an MTCH for one or more RedCap UEs (e.g., a second set of RedCap UEs) supporting a third capability having a third maximum bandwidth that is greater than the first maximum bandwidth and less than the second maximum bandwidth. For example, referring to FIG. 7, the base station 702 may output (for transmission to the set of UEs 704) and/or may transmit the set of one or more messages 706 that may include the first indication.

In some aspects, outputting the first indication of the CFR at 1002 may include (or be associated with) outputting (for transmission to the plurality of RedCap UEs) a first MCCH configuration for a first type of RedCap UE that is different from a second MCCH configuration for a second type of RedCap UE. The first MCCH configuration, in some aspects, may specify at least one of a first periodicity of MCCH resources or a first offset associated with the MCCH that may be different from a second periodicity of MCCH resources or a second offset associated specified by the second MCCH configuration. For example, referring to FIG. 7, the base station 702 may output (for transmission to the plurality of RedCap UEs) and/or transmit, the set of one or more messages 706 that may include the first MCCH configuration.

In some aspects, outputting the first indication of the CFR at 1002 may include (or be associated with) outputting (for transmission to the plurality of RedCap UEs) a first MTCH configuration for a first type of RedCap UE that is different from a second MTCH configuration for a second type of RedCap UE. The first MTCH configuration includes at least one of a first RM, a first LBRM, or a first set of RS configurations associated with the MTCH that is different from a second RM, a second LBRM, or a second set of RS configurations associated with the second MTCH configuration. For example, referring to FIG. 7, the base station 702 may output (for transmission to the set of UEs 704) and/or may transmit the set of one or more messages 706 that may include the first MTCH configuration.

Outputting the first indication of the CFR at 1002, in some aspects, may include (or be associated with) outputting (for transmission to the plurality of RedCap UEs) a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. Referring to FIG. 7, for example, the base station 702 may output (for transmission to the set of UEs 704) and/or may transmit the set of one or more messages 706 that may include the first list of neighbor cells.

In some aspects, outputting the first indication of the CFR at 1002 may include (or be associated with) outputting (for transmission to the plurality of RedCap UEs) a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. In some aspects, a PDSCH (or MTCH) communication scheduled by a PDCCH (or MCCH) associated with at least one of the G-RNTI or an MCCH-RNTI associated with the MTCH for the base station (or the plurality of RedCap UEs) may be associated with a set of PRBs spanning fewer than the first maximum bandwidth (e.g., 5 MHZ.) For example, referring to FIG. 7, the base station 702 may output (for transmission to the set of UEs 704) and/or may transmit the set of one or more messages 706 that may include the second indication.

Outputting the first indication of the CFR at 1002, in some aspects, may include (or be associated with) outputting (for transmission to the plurality of RedCap UEs) a third indication of a first MTCH neighbor cell configuration for the first G-RNTI that is different from a second MTCH neighbor cell configuration for the second G-RNTI. Referring to FIG. 7, for example, the base station 702 may output (for transmission to the set of UEs 704) and/or may transmit the set of one or more messages 706 that may include the third indication.

In some aspects, outputting the first indication of the CFR at 1002 may include (or be associated with) outputting (for transmission to the plurality of RedCap UEs) a first DRX configuration associated with a first type of RedCap UE that is different from a second DRX configuration for a second type of RedCap UE. Referring to FIG. 7, for example, the base station 702 may output (for transmission to the set of UEs 704) and/or may transmit the set of one or more messages 706 that may include the first DRX configuration.

At 1016, the base station may output (for transmission to the plurality of RedCap UEs) and/or may transmit at least one of an MCCH communication or an MTCH communication via the CFR indicated in the first indication for at least one of broadcast traffic or multicast traffic. Outputting the at least one of the MCCH communication or the MTCH communication at 1016, in some aspects, may include outputting (or transmitting) a PDSCH having (e.g., associated with or transmitted via) frequency resources spanning more than the first maximum bandwidth. In some aspects, Outputting the at least one of the MCCH communication or the MTCH communication at 1016, in some aspects, may include outputting (or transmitting) one or more PDSCH occasions limited to a span of the first maximum bandwidth (e.g., 5 MHz). For example, 1016 may be performed by CU processor(s) 1312, DU processor(s) 1332, RU processor(s) 1342, transceiver(s) 1346, antenna(s) 1380, and/or eRedCap MBS configuration component 199 of FIG. 13. Referring to FIG. 7, for example, the base station 702 may output (for transmission to the set of UEs 704) and/or may transmit the MCCH (or PDCCH) 710, the MTCH (or PDSCH) communication 712, or the MTCH (or PDSCH) communication 716.

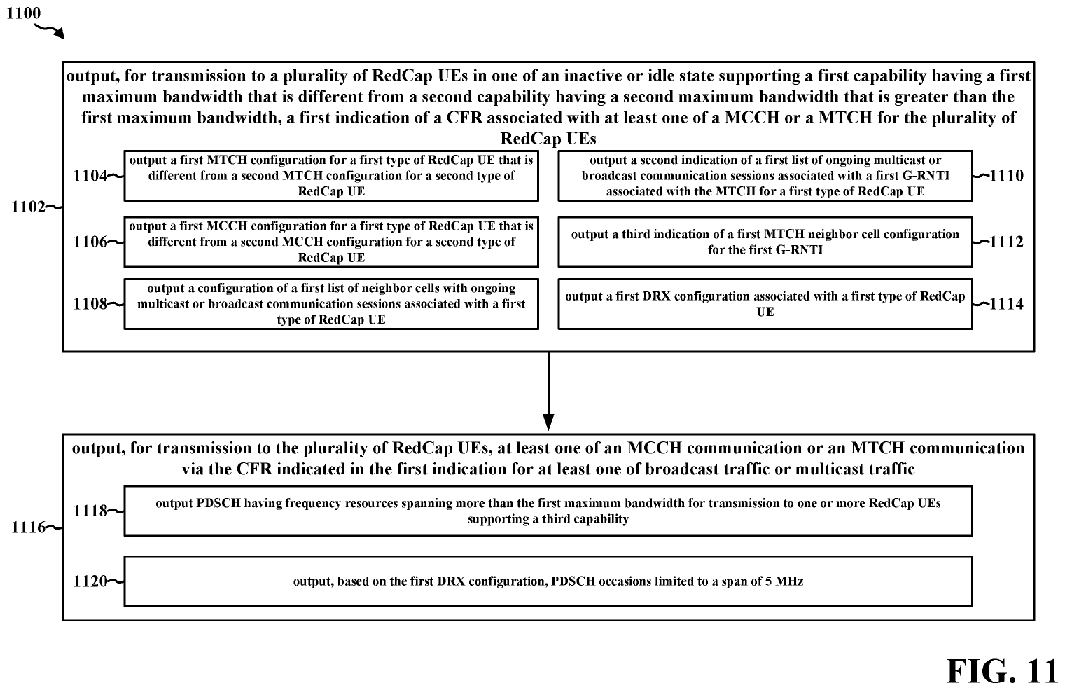

FIG. 11 is a flowchart 1100 of a method of wireless communication. The method may be performed by a network node or network device such as a base station (e.g., the base station 102, 412, 414, 702; the network entity 1202, 1302). At 1102, the base station may output (for transmission to a plurality of RedCap UEs in one of an inactive or idle state supporting a first capability having a first maximum bandwidth that is different from a second capability having a second maximum bandwidth that is greater than the first maximum bandwidth), and/or may transmit to the plurality of RedCap UEs, a first indication of a CFR associated with at least one of an MCCH or an MTCH for the plurality of RedCap UEs. For example, 1102 may be performed by CU processor(s) 1312, DU processor(s) 1332, RU processor(s) 1342, transceiver(s) 1346, antenna(s) 1380, and/or eRedCap MBS configuration component 199 of FIG. 13. The plurality of RedCap UEs, in some aspects, may be a first type RedCap UE (e.g., a UE implementing the first type of RedCap) supporting a first capability having a first maximum bandwidth (e.g., 5 MHz) that is different from a second capability having a second maximum bandwidth (e.g., 100 MHz or 20 MHZ) that is greater than the first maximum bandwidth. The first indication, in some aspects, may be included in an SIB. The first CFR, in some aspects, may be based on the first capability. The CFR, may be a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

The second capability may be a non-RedCap (e.g., or a full, or standard, capability) and a second CFR for an MBS may be specified for a set of non-RedCap UEs. In some aspects, the second capability may be a second type of RedCap supporting the second capability. The first indication may be included in a set of indications of the different CFRs for different types of RedCap UEs supporting the first capability. For example, different types of methods of complexity reduction (e.g., using a reduced number of total PRBs for PDSCH or a reduced BB BW for PUSCH described in relation to FIG. 5) may be employed in conjunction with the first capability.

In some aspects, the first CFR may be associated with at least one of the MCCH or the MTCH for multiple types of RedCap UEs. In some aspects, the multiple types of RedCap UEs may be defined based on at least one different value in a set of parameters associated with the type of RedCap (or type of RedCap UE) while a same CFR may be shared based on supporting a same maximum bandwidth (e.g., supporting the first capability). For example, a first type of RedCap (e.g., a first type of enhanced RedCap, or eRedCap device) may support a same maximum bandwidth as a second type of RedCap (e.g., a second type of eRedCap defined for Rel 18 or a second type of RedCap device) for reducing complexity.

The first CFR, in some aspects, may be different from a second CFR associated with at least one of an MCCH or an MTCH for one or more RedCap UEs (e.g., a second set of RedCap UEs) supporting a third capability having a third maximum bandwidth that is greater than the first maximum bandwidth and less than the second maximum bandwidth. For example, referring to FIG. 7, the base station 702 may output (for transmission to the set of UEs 704) and/or may transmit the set of one or more messages 706 that may include the first indication.

In some aspects, outputting the first indication of the CFR at 1102 may include (or be associated with) outputting (for transmission to the plurality of RedCap UEs), at 1104, a first MCCH configuration for a first type of RedCap UE that is different from a second MCCH configuration for a second type of RedCap UE. For example, 1104 may be performed by CU processor(s) 1312, DU processor(s) 1332, RU processor(s) 1342, transceiver(s) 1346, antenna(s) 1380, and/or eRedCap MBS configuration component 199 of FIG. 13. The first MCCH configuration, in some aspects, may specify at least one of a first periodicity of MCCH resources or a first offset associated with the MCCH that may be different from a second periodicity of MCCH resources or a second offset associated specified by the second MCCH configuration. For example, referring to FIG. 7, the base station 702 may output (for transmission to the plurality of RedCap UEs) and/or transmit, the set of one or more messages 706 that may include the first MCCH configuration.

In some aspects, outputting the first indication of the CFR at 1102 may include (or be associated with) outputting (for transmission to the plurality of RedCap UEs), at 1106, a first MTCH configuration for a first type of RedCap UE that is different from a second MTCH configuration for a second type of RedCap UE. For example, 1106 may be performed by CU processor(s) 1312, DU processor(s) 1332, RU processor(s) 1342, transceiver(s) 1346, antenna(s) 1380, and/or eRedCap MBS configuration component 199 of FIG. 13. The first MTCH configuration includes at least one of a first RM, a first LBRM, or a first set of RS configurations associated with the MTCH that is different from a second RM, a second LBRM, or a second set of RS configurations associated with the second MTCH configuration. For example, referring to FIG. 7, the base station 702 may output (for transmission to the set of UEs 704) and/or may transmit the set of one or more messages 706 that may include the first MTCH configuration.

Outputting the first indication of the CFR at 1102, in some aspects, may include (or be associated with) outputting (for transmission to the plurality of RedCap UEs), at 1108, a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. For example, 1108 may be performed by CU processor(s) 1312, DU processor(s) 1332, RU processor(s) 1342, transceiver(s) 1346, antenna(s) 1380, and/or eRedCap MBS configuration component 199 of FIG. 13. Referring to FIG. 7, for example, the base station 702 may output (for transmission to the set of UEs 704) and/or may transmit the set of one or more messages 706 that may include the first list of neighbor cells.

In some aspects, outputting the first indication of the CFR at 1102 may include (or be associated with) outputting (for transmission to the plurality of RedCap UEs), at 1110, a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. For example, 1110 may be performed by CU processor(s) 1312, DU processor(s) 1332, RU processor(s) 1342, transceiver(s) 1346, antenna(s) 1380, and/or eRedCap MBS configuration component 199 of FIG. 13. In some aspects, a PDSCH (or MTCH) communication scheduled by a PDCCH (or MCCH) associated with at least one of the G-RNTI or an MCCH-RNTI associated with the MTCH for the base station (or the plurality of RedCap UEs) may be associated with a set of PRBs spanning fewer than the first maximum bandwidth (e.g., 5 MHZ.) For example, referring to FIG. 7, the base station 702 may output (for transmission to the set of UEs 704) and/or may transmit the set of one or more messages 706 that may include the second indication.

Outputting the first indication of the CFR at 1102, in some aspects, may include (or be associated with) outputting (for transmission to the plurality of RedCap UEs), at 1112, a third indication of a first MTCH neighbor cell configuration for the first G-RNTI that is different from a second MTCH neighbor cell configuration for the second G-RNTI. For example, 1112 may be performed by CU processor(s) 1312, DU processor(s) 1332, RU processor(s) 1342, transceiver(s) 1346, antenna(s) 1380, and/or eRedCap MBS configuration component 199 of FIG. 13. Referring to FIG. 7, for example, the base station 702 may output (for transmission to the set of UEs 704) and/or may transmit the set of one or more messages 706 that may include the third indication.

In some aspects, outputting the first indication of the CFR at 1102 may include (or be associated with) outputting (for transmission to the plurality of RedCap UEs), at 1114, a first DRX configuration associated with a first type of RedCap UE that is different from a second DRX configuration for a second type of RedCap UE. For example, 1114 may be performed by CU processor(s) 1312, DU processor(s) 1332, RU processor(s) 1342, transceiver(s) 1346, antenna(s) 1380, and/or eRedCap MBS configuration component 199 of FIG. 13. Referring to FIG. 7, for example, the base station 702 may output (for transmission to the set of UEs 704) and/or may transmit the set of one or more messages 706 that may include the first DRX configuration.

At 1116, the base station may output (for transmission to the plurality of RedCap UEs) and/or may transmit at least one of an MCCH communication or an MTCH communication via the CFR indicated in the first indication for at least one of broadcast traffic or multicast traffic. Outputting the at least one of the MCCH communication or the MTCH communication at 1116, in some aspects, may include outputting (or transmitting), at 1118, a PDSCH having (e.g., associated with or transmitted via) frequency resources spanning more than the first maximum bandwidth. In some aspects, Outputting the at least one of the MCCH communication or the MTCH communication at 1116, in some aspects, may include outputting (or transmitting), at 1120, one or more PDSCH occasions limited to a span of the first maximum bandwidth (e.g., 5 MHZ). For example, 1116, 1118, and 1120 may be performed by CU processor(s) 1312, DU processor(s) 1332, RU processor(s) 1342, transceiver(s) 1346, antenna(s) 1380, and/or eRedCap MBS configuration component 199 of FIG. 13. Referring to FIG. 7, for example, the base station 702 may output (for transmission to the set of UEs 704) and/or may transmit the MCCH (or PDCCH) 710, the MTCH (or PDSCH) communication 712, or the MTCH (or PDSCH) communication 716.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the eRedCap MBS component 198 may be configured to receive a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth. The eRedCap MBS component 198 may also be configured to monitor the CFR indicated in the first indication for at least one of broadcast traffic or multicast traffic. The eRedCap MBS component 198 may be within the cellular baseband processor(s) 1224, the application processor(s) 1206, or both the cellular baseband processor(s) 1224 and the application processor(s) 1206. The eRedCap MBS component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth. The apparatus 1204, and in particular the cellular baseband processor(s) 1224 and/or the application processor(s) 1206, may further include means for monitoring the CFR indicated in the first indication for at least one of broadcast traffic or multicast traffic. The apparatus 1204, and in particular the cellular baseband processor(s) 1224 and/or the application processor(s) 1206, may further include means for skipping decoding of a PDSCH communication based on the PDSCH communication having frequency resources spanning more than the first maximum bandwidth. The apparatus 1204, and in particular the cellular baseband processor(s) 1224 and/or the application processor(s) 1206, may further include means for receiving a first MCCH configuration for a first type of RedCap UE that is different from a second MCCH configuration for a second type of RedCap UE. The apparatus 1204, and in particular the cellular baseband processor(s) 1224 and/or the application processor(s) 1206, may further include means for receiving a first MTCH configuration for a first type of RedCap UE that is different from a second MTCH configuration for a second type of RedCap UE. The apparatus 1204, and in particular the cellular baseband processor(s) 1224 and/or the application processor(s) 1206, may further include means for receiving a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. The apparatus 1204, and in particular the cellular baseband processor(s) 1224 and/or the application processor(s) 1206, may further include means for receiving a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. The apparatus 1204, and in particular the cellular baseband processor(s) 1224 and/or the application processor(s) 1206, may further include means for receiving a third indication of a first MTCH neighbor cell configuration for the first G-RNTI that is different from a second MTCH neighbor cell configuration for the second G-RNTI. The apparatus 1204, and in particular the cellular baseband processor(s) 1224 and/or the application processor(s) 1206, may further include means for receiving a first DRX configuration associated with a first type of RedCap UE that is different from a second DRX configuration for a second type of RedCap UE. The apparatus 1204, and in particular the cellular baseband processor(s) 1224 and/or the application processor(s) 1206, may further include means for monitoring, based on the first DRX configuration, PDSCH occasions limited to a span of 5 MHZ. The means may be the eRedCap MBS component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means or in any of FIG. 8 or 9.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the eRedCap MBS configuration component 199 may be configured to output, for transmission to a plurality of RedCap UEs in one of an inactive or idle state supporting a first capability having a first maximum bandwidth that is different from a second capability having a second maximum bandwidth that is greater than the first maximum bandwidth, a first indication of a CFR associated with at least one of an MCCH or an MTCH for the plurality of RedCap UEs. The eRedCap MBS configuration component 199 may also be configured to output, for transmission to the plurality of RedCap UEs, at least one of an MCCH communication or an MTCH communication via the CFR indicated in the first indication for at least one of broadcast traffic or multicast traffic. The eRedCap MBS configuration component 199 may be within one or more processors of one or more of the CU 1310, DU 1330, and the RU 1340. The eRedCap MBS configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for outputting, for transmission to a plurality of RedCap UEs in one of an inactive or idle state supporting a first capability having a first maximum bandwidth that is different from a second capability having a second maximum bandwidth that is greater than the first maximum bandwidth, a first indication of a CFR associated with at least one of a MCCH or a MTCH for the plurality of RedCap UEs. In one configuration, the network entity 1302 may include means for outputting, for transmission to the plurality of RedCap UEs, at least one of an MCCH communication or an MTCH communication via the CFR indicated in the first indication for at least one of broadcast traffic or multicast traffic. In one configuration, the network entity 1302 may include means for outputting, for transmission to the plurality of RedCap UEs, a first MCCH configuration for a first type of RedCap UE that is different from a second MCCH configuration for a second type of RedCap UE. In one configuration, the network entity 1302 may include means for outputting, for transmission to the plurality of RedCap UEs, a first MTCH configuration for a first type of RedCap UE that is different from a second MTCH configuration for a second type of RedCap UE. In one configuration, the network entity 1302 may include means for outputting, for transmission to the plurality of RedCap UEs, a configuration of a first list of neighbor cells with ongoing multicast or broadcast communication sessions associated with a first type of RedCap UE that is different from a second list of neighbor cells with ongoing multicast or broadcast communication sessions associated with a second type of RedCap UE. In one configuration, the network entity 1302 may include means for outputting, for transmission to the plurality of RedCap UEs, a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE. In one configuration, the network entity 1302 may include means for outputting, for transmission to the plurality of RedCap UEs, a third indication of a first MTCH neighbor cell configuration for the first G-RNTI that is different from a second MTCH neighbor cell configuration for the second G-RNTI. In one configuration, the network entity 1302 may include means for outputting, for transmission to the plurality of RedCap UEs, a first DRX configuration associated with a first type of RedCap UE that is different from a second DRX configuration for a second type of RedCap UE. The means may be the eRedCap MBS configuration component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 10 and 11.

Various aspects of the disclosure relate generally to an MBS configuration for an eRedCap for an idle or inactive state and supporting a first capability having a first maximum bandwidth that is different from a second capability having a second maximum bandwidth that is greater than the first maximum bandwidth. The MBS configuration for the eRedCap may allow for MBS in association with an additional complexity reduction beyond a complexity reduction associated with previous RedCap capabilities. Some aspects more specifically relate to configuring a CFR (and/or other parameters) associated with the MBS configuration for the eRedCap. In some aspects, a base station may transmit, and a UE (e.g., an eRedCap UE) may receive, an indication of a CFR (or additional parameters) associated with at least one of an MCCH or an MTCH for a plurality of RedCap (or eRedCap) UEs in one of an inactive or idle state supporting the first capability. The base station may then transmit, and the UE may monitor for, a transmission or communication via the CFR indicated in the first indication for at least one of broadcast traffic or multicast traffic. Particular aspects of the subject matter described in this disclosure can be implemented to realize one or more of the following potential advantages. The MBS configuration for the RedCap (or eRedCap) for an idle or inactive state and supporting a first capability may improve complexity reduction associated with multicast or broadcast for the eRedCap UE in one of an idle or inactive state for multicast or broadcast communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including receiving a first indication of a CFR associated with at least one of an MCCH or an MTCH for a plurality of RedCap UEs in one of an inactive or idle state supporting a first capability having a first maximum bandwidth that is different from a second capability having a second maximum bandwidth that is greater than the first maximum bandwidth, and monitoring the CFR indicated in the first indication for at least one of broadcast traffic or multicast traffic.

Aspect 2 is the method of aspect 1, where the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

Aspect 3 is the method of any of aspects 1 and 2, where different CFRs are indicated for different types of RedCap UEs supporting the first capability.

Aspect 4 is the method of any of aspects 1 to 3, where the CFR is further associated with at least one of the MCCH or the MTCH for multiple types of RedCap UEs.

Aspect 5 is the method of aspect 4, further including skipping decoding of a PDSCH communication based on the PDSCH communication having frequency resources spanning more than the first maximum bandwidth.

Aspect 6 is the method of any of aspects 1 to 5, where the first indication is included in an SIB.

Aspect 7 is the method of any of aspects 1 to 6, further including receiving a first MCCH configuration for a first type of RedCap UE that is different from a second MCCH configuration for a second type of RedCap UE where the first MCCH configuration specifies at least one of a first periodicity of MCCH resources or a first offset associated with the MCCH that is different from a second periodicity of MCCH resources or a second offset associated specified by the second MCCH configuration.

Aspect 8 is the method of any of aspects 1 to 7, further including receiving a first MTCH configuration for a first type of RedCap UE that is different from a second MTCH configuration for a second type of RedCap UE where the first MTCH configuration includes at least one of a first RM, a first LBRM, or a first set of RS configurations associated with the MTCH that is different from a second RM, a second LBRM, or a second set of RS configurations associated with the second MTCH configuration.

Aspect 9 is the method of any of aspects 1 to 8, further including receiving a configuration of a first list of neighbor cells with a first set of one or more ongoing multicast or broadcast communication sessions associated with a first type of RedCap UE that is different from a second list of neighbor cells with a second set of one or more ongoing multicast or broadcast communication sessions associated with a second type of RedCap UE.

Aspect 10 is the method of any of aspects 1 to 9, further including receiving a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE.

Aspect 11 is the method of aspect 10, where a PDSCH communication scheduled by a PDCCH associated with at least one of the G-RNTI or a MCCH-RNTI associated with the MTCH for the plurality of RedCap UEs is associated with a set of physical resource blocks spanning fewer than 5 MHZ.

Aspect 12 is the method of any of aspects 1 and 2, further including receiving a third indication of a first MTCH neighbor cell configuration for the first G-RNTI that is different from a second MTCH neighbor cell configuration for the second G-RNTI.

Aspect 13 is the method of any of aspects 1 to 12, further including receiving a first DRX configuration associated with a first type of RedCap UE that is different from a second DRX configuration for a second type of RedCap UE.

Aspect 14 is the method of aspect 13, further including monitoring, based on the first DRX configuration, PDSCH occasions limited to a span of 5 MHz.

Aspect 15 is a method of wireless communication at a network device, including outputting, for transmission to a plurality of RedCap UEs in one of an inactive or idle state supporting a first capability having a first maximum bandwidth that is different from a second capability having a second maximum bandwidth that is greater than the first maximum bandwidth, a first indication of a CFR associated with at least one of an MCCH or an MTCH for the plurality of RedCap UEs, and outputting, for transmission to the plurality of RedCap UEs, at least one of an MCCH communication or an MTCH communication via the CFR indicated in the first indication for at least one of broadcast traffic or multicast traffic.

Aspect 16 is the method of aspect 15, where the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

Aspect 17 is the method of any of aspects 15 and 16, where different CFRs are indicated for different types of RedCap UEs supporting the first capability.

Aspect 18 is the method of any of aspects 15 to 17, where the CFR is further associated with at least one of the MCCH or the MTCH for multiple types of RedCap UEs.

Aspect 19 is the method of any of aspects 15 to 18, where the first indication is included in an SIB.

Aspect 20 is the method of any of aspects 15 to 19, further including outputting, for transmission to the plurality of RedCap UEs, a first MCCH configuration for a first type of RedCap UE that is different from a second MCCH configuration for a second type of RedCap UE where the first MCCH configuration specifies at least one of a first periodicity of MCCH resources or a first offset associated with the MCCH that is different from a second periodicity of MCCH resources or a second offset associated specified by the second MCCH configuration.

Aspect 21 is the method of any of aspects 15 to 20, further including outputting, for transmission to the plurality of RedCap UEs, a first MTCH configuration for a first type of RedCap UE that is different from a second MTCH configuration for a second type of RedCap UE where the first MTCH configuration includes at least one of a first RM, a first LBRM, or a first set of RS configurations associated with the MTCH that is different from a second RM, a second LBRM, or a second set of RS configurations associated with the second MTCH configuration.

Aspect 22 is the method of any of aspects 15 to 21, further including outputting, for transmission to the plurality of RedCap UEs, a configuration of a first list of neighbor cells with a first set of one or more ongoing multicast or broadcast communication sessions associated with a first type of RedCap UE that is different from a second list of neighbor cells with a second set of one or more ongoing multicast or broadcast communication sessions associated with a second type of RedCap UE.

Aspect 23 is the method of any of aspects 15 to 22, further including outputting, for transmission to the plurality of RedCap UEs, a second indication of a first list of ongoing multicast or broadcast communication sessions associated with a first G-RNTI associated with the MTCH for a first type of RedCap UE that is different from a second list of ongoing multicast or broadcast communication sessions associated with a second G-RNTI associated with the MTCH for a second type of RedCap UE.

Aspect 24 is the method of any of aspects 23, further including outputting, for transmission to the plurality of RedCap UEs, a third indication of a first MTCH neighbor cell configuration for the first G-RNTI that is different from a second MTCH neighbor cell configuration for the second G-RNTI.

Aspect 25 is the method of any of aspects 15 to 24, further including outputting, for transmission to the plurality of RedCap UEs, a first DRX configuration associated with a first type of RedCap UE that is different from a second DRX configuration for a second type of RedCap UE.

Aspect 26 is an apparatus for wireless communication at a device including at least one memory and at least one processor coupled to the at least one memory and, based at least in part on information stored in the memory, the at least one processor, individually or in any combination, is configured to implement any of aspects 1 to 25.

Aspect 27 is the apparatus of aspect 26, further including at least one transceiver or at least one antenna coupled to the at least one processor.

Aspect 28 is an apparatus for wireless communication at a device including means for implementing any of aspects 1 to 25.

Aspect 29 is a computer-readable medium (e.g., a non-transitory computer-readable medium) storing computer executable code, where the code when executed by at least one processor causes the at least one processor, individually or in any combination, to implement any of aspects 1 to 25.

What is claimed is:

1. An apparatus for wireless communication at a wireless device, comprising:
at least one memory; and
at least one processor coupled to the at least one memory and, based at least in part on information stored in the at least one memory, the at least one processor, individually or in any combination, is configured to:
receive a first indication of a common frequency resource (CFR) associated with at least one of a multicast control channel (MCCH) or a multicast traffic channel (MTCH) for a plurality of reduced capability (RedCap) UEs in one of an inactive or idle state supporting a first capability having a first maximum bandwidth that is different from a second capability having a second maximum bandwidth that is greater than the first maximum bandwidth; and
monitor the CFR indicated in the first indication for at least one of broadcast traffic or multicast traffic.

2. The apparatus of claim 1, wherein the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

3. The apparatus of claim 1, wherein different CFRs are associated with different types of RedCap UEs supporting the first capability.

4. The apparatus of claim 1, wherein the CFR is further associated with at least one of the MCCH or the MTCH for multiple types of RedCap UEs.

5. The apparatus of claim 4, wherein the at least one processor, individually or in any combination, is further configured to:
skip decoding of a physical downlink shared channel (PDSCH) communication based on the PDSCH communication having frequency resources spanning more than the first maximum bandwidth.

6. The apparatus of claim 1, wherein the at least one processor, individually or in any combination, is further configured to receive the first indication in a system information block (SIB).

7. The apparatus of claim 1, wherein the at least one processor, individually or in any combination, is further configured to:
receive a first MCCH configuration for a first type of RedCap UE that is different from a second MCCH configuration for a second type of RedCap UE wherein the first MCCH configuration specifies at least one of a first periodicity of MCCH resources or a first offset associated with the MCCH that is different from a second periodicity of MCCH resources or a second offset associated specified by the second MCCH configuration.

8. The apparatus of claim 1, wherein the at least one processor, individually or in any combination, is further configured to:
receive a first MTCH configuration for a first type of RedCap UE that is different from a second MTCH configuration for a second type of RedCap UE wherein the first MTCH configuration includes at least one of a first rate matching (RM), a first limited buffer RM (LBRM), or a first set of reference signal (RS) configurations associated with the MTCH that is different from a second RM, a second LBRM, or a second set of RS configurations associated with the second MTCH configuration.

9. The apparatus of claim 1, wherein the at least one processor, individually or in any combination, is further configured to:
receive a configuration of a first list of neighbor cells with a first set of one or more ongoing multicast or broadcast communication sessions associated with a first type of RedCap UE that is different from a second list of neighbor cells with a second set of one or more ongoing multicast or broadcast communication sessions associated with a second type of RedCap UE.

10. The apparatus of claim 1, wherein the at least one processor, individually or in any combination, is further configured to:
receive a second indication of a first list of ongoing multicast or broadcast communication sessions associated with a first group radio network temporary identifier (G-RNTI) associated with the MTCH for a first type of RedCap UE that is different from a second list of ongoing multicast or broadcast communication sessions associated with a second G-RNTI associated with the MTCH for a second type of RedCap UE.

11. The apparatus of claim 10, wherein a physical downlink shared channel (PDSCH) communication scheduled by a physical downlink control channel (PDCCH) associated with at least one of the G-RNTI or a MCCH-RNTI associated with the MTCH for the plurality of RedCap UEs is associated with a set of physical resource blocks spanning fewer than 5 MHz.

12. The apparatus of claim 10, wherein the at least one processor, individually or in any combination, is further configured to:
receive a third indication of a first MTCH neighbor cell configuration for the first G-RNTI that is different from a second MTCH neighbor cell configuration for the second G-RNTI.

13. The apparatus of claim 1, wherein the at least one processor, individually or in any combination, is further configured to:
receive a first discontinuous reception (DRX) configuration associated with a first type of RedCap UE that is different from a second DRX configuration for a second type of RedCap UE.

14. The apparatus of claim 13, wherein the at least one processor, individually or in any combination, is further configured to:
monitor, based on the first DRX configuration, physical downlink shared channel (PDSCH) occasions limited to a span of 5 MHz.

15. An apparatus for wireless communication at network device, comprising:
at least one memory; and
at least one processor coupled to the at least one memory and, based at least in part on information stored in the at least one memory, the at least one processor, individually or in any combination, is configured to:
output, for transmission to a plurality of reduced capability (RedCap) user equipments (UEs) in one of an inactive or idle state supporting a first capability having a first maximum bandwidth that is different from a second capability having a second maximum bandwidth that is greater than the first maximum bandwidth, a first indication of a common frequency resource (CFR) associated with at least one of a multicast control channel (MCCH) or a multicast traffic channel (MTCH) for the plurality of RedCap UEs; and
output, for transmission to the plurality of RedCap UEs, at least one of an MCCH communication or an MTCH communication via the CFR indicated in the first indication for at least one of broadcast traffic or multicast traffic.

16. The apparatus of claim 15, wherein the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

17. The apparatus of claim 15, wherein different CFRs are associated with different types of RedCap UEs supporting the first capability.

18. The apparatus of claim 15, wherein the CFR is further associated with at least one of the MCCH or the MTCH for multiple types of RedCap UEs.

19. The apparatus of claim 15, wherein the first indication is comprised in a system information block (SIB).

20. The apparatus of claim 15, wherein the at least one processor, individually or in any combination, is further configured to:
output, for transmission to the plurality of RedCap UEs, a first MCCH configuration for a first type of RedCap UE that is different from a second MCCH configuration for a second type of RedCap UE wherein the first MCCH configuration specifies at least one of a first periodicity of MCCH resources or a first offset associated with the MCCH that is different from a second periodicity of MCCH resources or a second offset associated specified by the second MCCH configuration.

21. The apparatus of claim 15, wherein the at least one processor, individually or in any combination, is further configured to:
output, for transmission to the plurality of RedCap UEs, a first MTCH configuration for a first type of RedCap UE that is different from a second MTCH configuration for a second type of RedCap UE wherein the first MTCH configuration includes at least one of a first rate matching (RM), a first limited buffer RM (LBRM), or a first set of reference signal (RS) configurations associated with the MTCH that is different from a second RM, a second LBRM, or a second set of RS configurations associated with the second MTCH configuration.

22. The apparatus of claim 15, wherein the at least one processor, individually or in any combination, is further configured to:
output, for transmission to the plurality of RedCap UEs, a configuration of a first list of neighbor cells with a first set of one or more ongoing multicast or broadcast communication sessions associated with a first type of RedCap UE that is different from a second list of neighbor cells with a second set of one or more ongoing multicast or broadcast communication sessions associated with a second type of RedCap UE.

23. The apparatus of claim 15, wherein the at least one processor, individually or in any combination, is further configured to:
output, for transmission to the plurality of RedCap UEs, a second indication of a first list of ongoing multicast or broadcast communication sessions associated with a first group radio network temporary identifier (G-RNTI) associated with the MTCH for a first type of RedCap UE that is different from a second list of ongoing multicast or broadcast communication sessions associated with a second G-RNTI associated with the MTCH for a second type of RedCap UE.

24. The apparatus of claim 23, wherein the at least one processor, individually or in any combination, is further configured to:
output, for transmission to the plurality of RedCap UEs, a third indication of a first MTCH neighbor cell configuration for the first G-RNTI that is different from a second MTCH neighbor cell configuration for the second G-RNTI.

25. The apparatus of claim 15, wherein the at least one processor, individually or in any combination, is further configured to:
output, for transmission to the plurality of RedCap UEs, a first discontinuous reception (DRX) configuration associated with a first type of RedCap UE that is different from a second DRX configuration for a second type of RedCap UE.

26. A method for wireless communication at a wireless device (UE), comprising:
receiving a first indication of a common frequency resource (CFR) associated with at least one of a multicast control channel (MCCH) or a multicast traffic channel (MTCH) for a plurality of reduced capability (RedCap) UEs in one of an inactive or idle state supporting a first capability having a first maximum bandwidth that is different from a second capability having a second maximum bandwidth that is greater than the first maximum bandwidth; and
monitoring the CFR indicated in the first indication for at least one of broadcast traffic or multicast traffic.

27. The method of claim 26, wherein the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.

28. The method of claim 26, further comprising:
receiving a first discontinuous reception (DRX) configuration associated with a first type of RedCap UE that is different from a second DRX configuration for a second type of RedCap UE.

29. A method for wireless communication at a network device, comprising:
outputting, for transmission to a plurality of reduced capability (RedCap) user equipments (UEs) in one of an inactive or idle state supporting a first capability having a first maximum bandwidth that is different from a second capability having a second maximum bandwidth that is greater than the first maximum bandwidth, a first indication of a common frequency resource (CFR) associated with at least one of a multicast control channel (MCCH) or a multicast traffic channel (MTCH) for the plurality of RedCap UEs; and
outputting, for transmission to the plurality of RedCap UEs, at least one of an MCCH communication or an MTCH communication via the CFR indicated in the first indication for at least one of broadcast traffic or multicast traffic.

30. The method of claim 29, wherein the CFR is a first CFR that is different from a second CFR associated with at least one of the MCCH or the MTCH for one or more RedCap UEs supporting a third capability having a third maximum bandwidth that is greater than the first maximum bandwidth and less than the second maximum bandwidth.
